(19) United States
(12) Patent Application Publication
(10) Pub. No.: US 2025/0133366 A1
(43) Pub. Date: Apr. 24, 2025

(54) AUDIO RENDERING SUITABLE FOR REVERBERANT ROOMS

(71) Applicant: Fraunhofer-Gesellschaft zur Förderung der angewandten Forschung e.V., München (DE)

(72) Inventors: Sascha DISCH, Erlangen (DE); Vensan MAZMANYAN, Erlangen (DE); Marvin TRÜMPER, Erlangen (DE); Alexander ADAMI, Erlangen (DE); Jürgen HERRE, Erlangen (DE); Andreas SILZLE, Erlangen (DE); Christof FALLER, Greifensee (CH); Markus SCHMIDT, Lausanne (CH)

(73) Assignee: Fraunhofer-Gesellschaft zur Förderung der angewandten Forschung e.V., München (DE)

(21) Appl. No.: 19/007,440

(22) Filed: Dec. 31, 2024

Related U.S. Application Data
(63) Continuation of application No. PCT/EP2023/068832, filed on Jul. 7, 2023.

(30) Foreign Application Priority Data
Jul. 12, 2022 (EP) 22184528.2

(51) Int. Cl. H04S 7/00; H04R 5/02

(52) U.S. Cl. CPC H04S 7/305; H04R 5/02; H04S 7/303; H04S 7/307; H04S 2400/11; H04S 2400/13

(57) ABSTRACT

Audio processor for performing audio rendering by generating rendering parameters, which determine a derivation of loudspeaker signals to be reproduced by a set of loudspeakers from an audio signal. The audio processor is configured to obtain a reverberation effect information and to perform a gain adjustment so as to determine, based on a listener position, gains for generating the loudspeaker signals for the loudspeakers from the audio signal. The audio processor is configured to use, depending on the reverberation effect information, in the gain adjustment, for at least one loudspeaker, a roll-off gain compensation function for mapping a listener-to-loudspeaker distance of the at least one loudspeaker onto a listener-to-loudspeaker-distance compensation gain for the at least one loudspeaker, for which a compensated roll-off gets monotonically shallower with increasing listener-to-loudspeaker distance.

### CROSS-REFERENCE TO RELATED APPLICATIONS

This application is a continuation of copending International Application No. PCT/EP2023/068832, filed Jul. 7, 2023, which is incorporated herein by reference in its entirety, and additionally claims priority from European Application No EP 22184528.2, filed Jul. 12, 2022, which is also incorporated herein by reference in its entirety.

Embodiments according to the invention relate to an audio processor, a system, a method and a computer program for audio rendering such as, for example, a user-adaptive loudspeaker rendering for reverberant rooms.

### BACKGROUND OF THE INVENTION

A general problem in audio reproduction with loudspeakers is that usually reproduction is optimal only within one or a small range of listener positions. Even worse, when a listener changes position or is moving, then the quality of the audio reproduction highly varies. The evoked spatial auditory image is unstable for changes of the listening position away from the sweet-spot. The stereophonic image collapses into the closest loudspeaker.

This problem has been addressed by previous publications, including [1] by tracking a listener's position and adjusting gain and delay to compensate deviations from the optimal listening position. [2] shows an extension on how to adapt also to the spatial radiation characteristics of the used loudspeakers. Listener tracking has also been used with cross talk cancellation (XTC), see, for example, [3]. XTC needs extremely precise positioning of a listener, which makes listener tracking almost indispensable.

Previous methods for listener position adaptive gain compensation for loudspeaker signals assume that there is a tendency of a constant roll-off of sound energy (and thus needed compensation gain) over distance. As an example, the theoretical roll-off (“slope”) of the acoustic energy over this distance would be 6 dB per distance doubling for an acoustic point source. Other slope values may be applied as well. In practice, however, these dependencies only work for very dry conditions (close to anechoic rooms) which can be found rarely in real-world sound reproduction environments.

Therefore, it is desired to get a concept which involves a compensation gain scheme that also is able to account for reproduction environments which include some amount of reverberant sound with the aim of optimizing the quality of an output audio signal of a loudspeaker for a listener at different listening positions.

### SUMMARY

An embodiment may have an audio processor for performing audio rendering by generating rendering parameters, which determine a derivation of loudspeaker signals to be reproduced by a set of loudspeakers from an audio signal, configured to perform a gain adjustment so as to determine, based on a listener position, gains for generating the loudspeaker signals for the loudspeakers from the audio signal, obtain a reverberation effect information; wherein the audio processor is configured to use, depending on the reverberation effect information, in the gain adjustment, for at least one loudspeaker, a roll-off gain compensation function for mapping a listener-to-loudspeaker distance of the at least one loudspeaker onto a listener-to-loudspeaker-distance compensation gain (46) for the at least one loudspeaker, wherein the roll-off gain compensation function considers a first decay parameter for a near-field and a second decay parameter for a far-field, so that a compensated roll-off gets monotonically shallower with increasing listener-to-loudspeaker distance.

According to another embodiment, a method for audio rendering by generating rendering parameters, which determine a derivation of loudspeaker signals to be reproduced by a set of loudspeakers from an audio signal, the method comprising: performing a gain adjustment so as to determine, based on a listener position, gains for generating the loudspeaker signals for the loudspeakers from the audio signal, obtaining a reverberation effect information; wherein, depending on the reverberation effect information, the gain adjustment uses, for at least one loudspeaker, a roll-off gain compensation function for mapping a listener-to-loudspeaker distance of the at least one loudspeaker onto a listener-to-loudspeaker-distance compensation gain for the at least one loudspeaker, wherein the roll-off gain compensation function considers a first decay parameter for a near-field and a second decay parameter for a far-field, so that a compensated roll-off gets monotonically shallower with increasing listener-to-loudspeaker distance.

Another embodiment may have a non-transitory digital storage medium having a computer program stored thereon to perform the inventive method for audio rendering by generating rendering parameters, when said computer program is run by a computer.

Another embodiment may have a bitstream (or digital storage medium storing the same).

It is the objective of this invention to provide a more realistic distance gain compensation that considers the fact that there is reverberant energy in realistic reproduction environments (rooms/reproduction spaces). This difficulty is overcome by considering reverberation effect information at the gain adjustment/compensation. Especially a roll-off gain compensation function for mapping a listener-to-loudspeaker distance onto a compensation gain is used, which considers, for example, an effect of the reverberation. It is an idea of the underlying embodiments of the present invention that the gain which is to be compensated does not increase uniformly, i.e. with a fixed factor, with increasing distance of a listener to a loudspeaker due to a presence of reverb in the sound reproduction environment. This is based on the realization that the acoustic energy rolls off more slowly with growing distance between the loudspeaker location and the listener in a realistic room than it would be the case for anechoic reproduction environments. The attenuation of sound energy, for example, may decrease with increasing distance of the listener to the loudspeaker due to reverb. This correlation, for example, is reflected by the roll-off gain compensation function which takes into account that the roll-off compensated by the compensation gain gets monotonically shallower with increasing listener-to-loudspeaker distance. Although using the roll-off gain compensation function in such a manner seems to increase the computational complexity compared to gain adjustments considering a constant roll-off of sound energy, this gain adjustment increases, in fact, the stability of the rendering and a precision of a sound reproduced by the loudspeakers at a listener position.

Accordingly, an embodiment relates to an audio processor for performing audio rendering by generating rendering parameters, which determine a derivation of loudspeaker signals to be reproduced by a set of loudspeakers from an audio signal. The audio processor is configured to obtain a reverberation effect information and to perform a gain adjustment so as to determine, based on a listener position, gains for generating the loudspeaker signals for the loudspeakers from the audio signal. The audio processor is configured to use, depending on the reverberation effect information, in the gain adjustment, for at least one loudspeaker, a roll-off gain compensation function for mapping a listener-to-loudspeaker distance of the at least one loudspeaker onto a listener-to-loudspeaker-distance compensation gain for the at least one loudspeaker, for which a compensated roll-off gets monotonically shallower with increasing listener-to-loudspeaker distance. In other words, the roll-off gain compensation function may be configured to compensate a roll-off of sound energy that gets monotonically shallower with increasing listener-to-loudspeaker distance, i.e. the roll-off of sound energy gets reduced with increasing listener-to-loudspeaker distance. A slope of the roll-off gain compensation function may get monotonically shallower with increasing listener-to-loudspeaker distance. For example, “shallower” in terms of the compensation gain increases at large listener-to-loudspeaker distances more slowly than at small listener-to-loudspeaker distances, i.e. the compensation gain increases with a smaller rate at increasing listener-to-loudspeaker distance.

The reverberation effect information, for example, may be indicative of an amount of reverberation effective in a reproduction room of the audio rendering or may be indicative of whether reverberation is effective in the reproduction room of the audio rendering, or not. According to an embodiment, the reverberation effect information may comprise a first compensated roll-off slope of the roll-off gain compensation function, a second compensated roll-off slope of the roll-off gain compensation function, a nearfield decay parameter, a farfield decay parameter, a critical distance parameter and/or a nearfield-farfield transition parameter. The first compensated roll-off slope and the second compensated roll-off slope may be indicative a compensation gain per distance or of sound energy per distance. The nearfield decay parameter and the farfield decay parameter may be indicative of a roll-off of acoustic energy per distance, wherein the nearfield decay parameter may indicate a higher decay compared to the farfield decay parameter. The first compensated roll-off slope may be related to the nearfield decay parameter and the second compensated roll-off slope may be related to the farfield decay parameter. The critical distance parameter may be indicative of a distance, e.g., a border distance, to a loudspeaker of the set of loudspeakers, wherein the distance separates two distance zones associated with different reverberation effect. For example, a first distance zone, i.e. the nearfield, with a distance smaller than the border distance may be associated with a higher roll-off of sound energy than a second distance zone, i.e. the farfield, with a distance greater than the border distance. The critical distance parameter may be indicative of a distance to a loudspeaker of the set of loudspeakers at which the energy of the direct sound is equal to the energy of the reverberant sound. The nearfield-farfield transition parameter may indicate how fast a transition between the nearfield decay and farfield decay is, e.g., how the roll-off gain compensation function transitions from the first to the second distance zone.

The listener position may be defined by coordinates indicating a position of a listener within a reproduction space, e.g. a position of the body of the listener, of the head of the listener or of the ears of the listener, e.g., tracking data. The listener position, for example, may be described in cartesian coordinates, in spherical coordinates or in cylindrical coordinates. Alternative to an absolute position of the listener, it is possible that the listener position indicates a relative position of the listener, e.g. relative to a reference loudspeaker of the set of loudspeakers or relative to each loudspeaker of the set of loudspeakers or relative to a sweet spot within the reproduction space or relative to any other predetermined position within the reproduction space.

A further embodiment relates to a method for audio rendering by generating rendering parameters, which determine a derivation of loudspeaker signals to be reproduced by a set of loudspeakers from an audio signal. The method comprises obtaining a reverberation effect information and performing a gain adjustment so as to determine, based on a listener position, gains for generating the loudspeaker signals for the loudspeakers from the audio signal. Depending on the reverberation effect information, the gain adjustment uses, for at least one loudspeaker, a roll-off gain compensation function for mapping a listener-to-loudspeaker distance of the at least one loudspeaker onto a listener-to-loudspeaker-distance compensation gain for the at least one loudspeaker, for which a compensated roll-off gets monotonically shallower with increasing listener-to-loudspeaker distance.

A further embodiment relates to a computer program or digital storage medium storing the same. The computer program has a program code for instructing, when the program is executed on a computer, the computer to perform one of the herein described methods.

A further embodiment relates to a bitstream or digital storage medium storing the same, as mentioned herein. The bitstream, for example, may comprise the reverberation effect information and/or the listener position and/or the loudspeaker signals and or the audio signal.

The method, the computer program and the bitstream as described herein are based on the same considerations as the herein-described audio processor. The method, the computer program and the bitstream can, by the way, be completed with all features and/or functionalities, which are also described with regard to the audio processor.

### BRIEF DESCRIPTION OF THE DRAWINGS

Embodiments of the present invention will be detailed subsequently referring to the appended drawings, in which:

FIG. 1 shows a schematic view of an embodiment of an audio processor determining gains and delays;

FIG. 2 shows a schematic view of an embodiment of amplitude panning;

FIG. 3 shows a schematic view of an embodiment of an audio processor configured for gain adjustment;

FIG. 4 shows a plot depicting schematically compensation gain versus listener-to-loudspeaker distance;

FIG. 5 shows a level 1 processing system as an example for a herein described audio processor;

FIG. 6 shows an example for a roll-off gain compensation function,

FIG. 7 shows exemplarily a code snippet of an initialization stage;

FIG. 8 shows exemplarily a code snippet of a release stage:

FIG. 9 shows exemplarily a code snippet of the reset stage;

FIGS. 10a to 10i show exemplary code snippets of a real-time parameters update stage; and

FIGS. 11a to 11c show exemplarily code snippets of an audio processing stage.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In the following, various examples are described which may assist in achieving a more effective compression when using listener position controlled gain and/or delay adjustment. The gain adjustment and/or the delay adjustment may be added to other parameter adjustments for sound rendition, for instance, or may be provided exclusively.

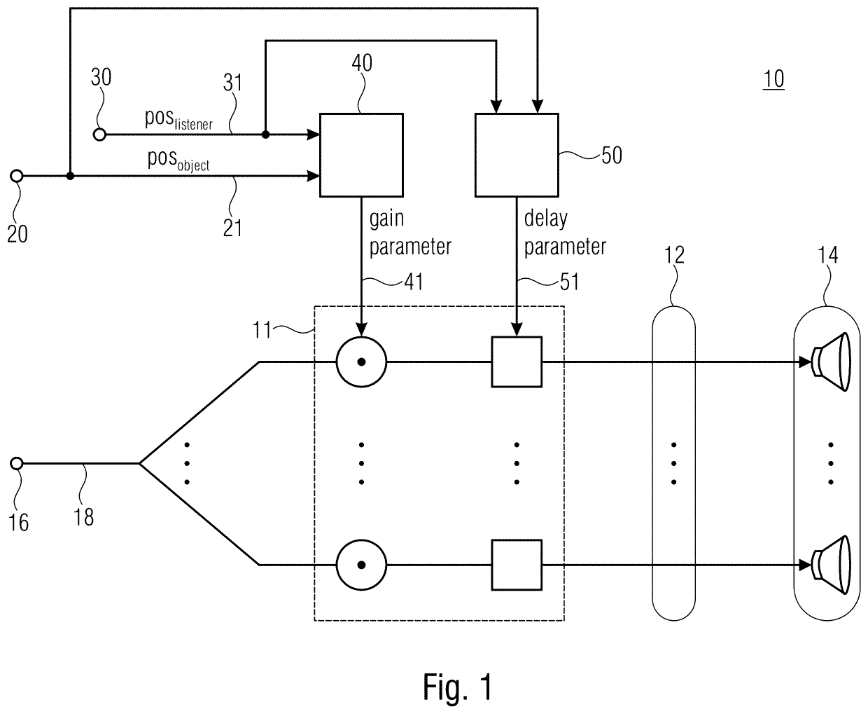

In order to ease the understanding of the following examples of the present application, the description starts with a presentation of a possible apparatus fitting thereto into which the subsequently outlined examples of the present application could be built. The following description starts with a description of an embodiment of an apparatus for generating loudspeaker signals for a plurality of loudspeakers. More specific embodiments are outlined herein below along with a description of details which may, individually or in groups, apply to the apparatus of FIG. 1.

The apparatus of FIG. 1 is generally indicated using reference sign 10 and is for generating loudspeaker signals 12 for a plurality of loudspeakers 14 in a manner so that an application of the loudspeaker signals 12 at or to the plurality of loudspeakers 14 renders at least one audio object at an intended virtual position.

The apparatus 10 might be configured for a certain arrangement of loudspeakers 14, i.e., for certain positions in which the plurality of loudspeakers 14 are positioned or positioned and oriented. The apparatus may, however, alternatively be able to be configurable for different loudspeaker arrangements of loudspeakers 14. Likewise, the number of loudspeakers 14 may be two or more and the apparatus may be designed for a set number of loudspeakers 14 or may be configurable to deal with any number of loudspeakers 14.

The apparatus 10 comprises an interface 16 at which apparatus 10 receives an audio signal 18 which represents the at least one audio object. The apparatus 10, for example, may be configured to decode the audio signal 18 from a bitstream. For the time being, let's assume that the audio input signal 18 is a mono audio signal which represents the audio object such as the sound of a helicopter or the like. Additional examples and further details are provided below. Alternatively, the audio input signal 18 may be a stereo audio signal or a multichannel audio signal. In any case, the audio signal 18 may represent the audio object in time domain, in frequency domain or in any other domain and it may represent the audio object in a compressed manner or without compression.

As depicted in FIG. 1, the apparatus 10 further comprises an object position input 20 for receiving the intended virtual position 21. That is, at the object position input 20, the apparatus 10 is notified about the intended virtual position 21 to which the audio object shall virtually be rendered by the application of the loudspeaker signals 12 at loudspeakers 14. That is, the apparatus 10 receives at input 20 the information of the intended virtual position 21, and this information may be provided relative to the arrangement/position of loudspeakers 14, relative to a sweet spot, relative to the position and/or head orientation of the listener and/or relative to real-world coordinates. This information could e.g. be based on Cartesian coordinate systems, or polar coordinate systems. It could e.g. be based on a room centric coordinate system or a listener centric coordinate system, either as a cartesian, or polar coordinate system.

Additionally, the apparatus 10 comprises a listener position input 30 for receiving the actual position of the listener. The listener position 31 may be defined by coordinates indicating a position of a listener within a reproduction space, e.g. a position of the body of the listener, of the head of the listener or of the ears of the listener, e.g., tracking data, i.e. information of the position of the listener over time. The listener position 31, for example, may be described in cartesian coordinates, in spherical coordinates or in cylindrical coordinates. Alternative to an absolute position of the listener, it is possible that the listener position 31 indicates a relative position of the listener, e.g. relative to a reference loudspeaker of the set of loudspeakers or relative to a sweet spot within the reproduction space or relative to any other predetermined position within the reproduction space.

For example, in case the intended virtual position 21 defines the position of an audio object relative to the listener position 31, the apparatus 10 might not necessarily need the listener position input 30 for receiving the listener position 31. This is due to the fact that the intended virtual position 21 already considers the listener position 31.

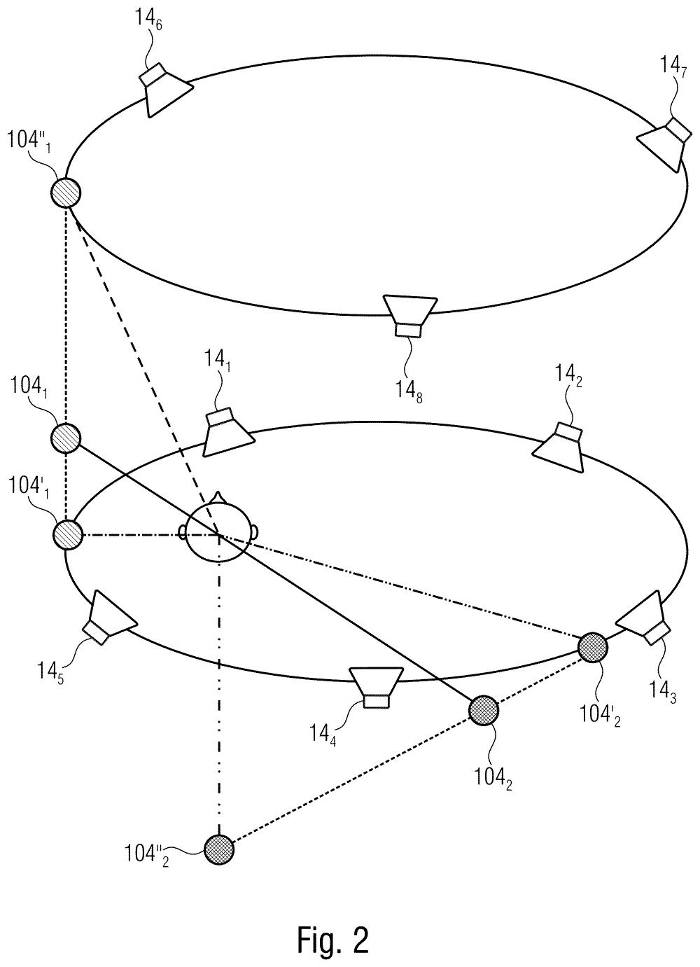

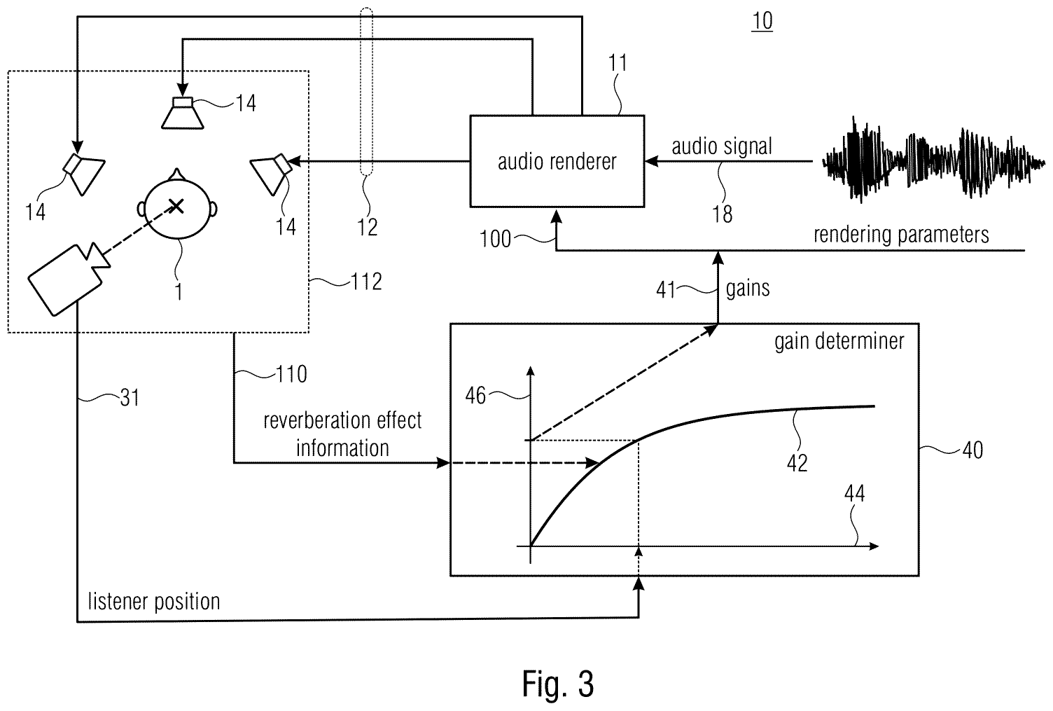

As depicted in FIG. 1, apparatus 10 may comprise a gain determiner 40 configured to determine, depending on the intended virtual position 21 received at input 20 and/or on the listener position 31 received at input 30, gains 41 for the plurality of loudspeakers 14. The gain determiner 40 may, according to an embodiment, compute amplitude gains, one for each loudspeaker signal, so that the intended virtual position 21 is panned between the plurality of loudspeakers 14 and/or so that a roll-off of sound energy is compensated. The gains 41 provided by the gain determiner 40 may represent compensation gains, as described with regard to FIG. 3. Alternatively, as outlined in more detail with regard to FIG. 2, the respective panning gain gₙ to be applied to the respective loudspeaker signal may comprise a horizontal component gₙ^{horizontal} and a vertical component gₙ^{vertical}, e.g., gₙ=gₙ^{horizontal}·gₙ^{vertical}, and optionally a further component corresponding to a compensation gain, see FIG. 3. The index n represents a positive integer in the range 1≤n≤i, wherein i represents the number of loudspeakers 14. The gain determiner 40 may be configured to determine for each loudspeaker the respective gain 41.

Additionally, or alternatively, the apparatus 10 may comprise a delay determiner/controller 50 to determine/control, depending on the intended virtual position 21 received at input 20 and/or on the listener position 31 received at input 30, delays 51 for the plurality of loudspeakers 14. The delay determiner 50 may be configured to determine for each loudspeaker the respective delay 51, so that the application of the loudspeaker signals 12 at or to the plurality of loudspeakers 14 renders at least one audio object at an intended virtual position and/or so that the loudspeaker signals reproduced by the loudspeakers 14 arrive at the listener at the same time.

The apparatus 10 may comprise an audio renderer 11 configured to render the audio signal 18 based on the gains 41 and/or the delays 51, so as to derive the loudspeaker signals 12 from the audio signal 18.

With regard to FIG. 2 a possible 3D panning performed by the panning gain determiner 40 is described in more detail.

The loudspeakers 14 can be arranged in one or more horizontal layers 15. As depicted in FIG. 2, a first set of loudspeakers 14₁ to 14₅ of the plurality of loudspeakers 14 may be arranged in a first horizontal layer 15₁ and a second set of loudspeakers 14₆ to 14₈ of the plurality of loudspeakers 14 may be arranged in a second horizontal layer 15₂. That is, the first set of loudspeakers 14₁ to 14₅, quasi, are arranged at similar heights and the second set of loudspeakers 14₆ to 14₈, quasi, are arranged at similar heights. The first set of loudspeakers 14₁ to 14₅ may be arranged at or near a first height and the second set of loudspeakers 14₆ to 14₈ may be arranged at or near a second height, e.g. above the first height. According to the embodiment shown in FIG. 2, the listener position 31 is exemplarily arranged within the first horizontal layer 15₁.

In the following, the case of rendering an object in 3D is explained for an example case where an object 104₁, e.g. a sound source, is panned in a direction (as seen from the listener 100) that lies between two physically present loudspeakers layers (which are at different height). The object 104₁ is amplitude panned in the first layer 15₁ by giving the object signal to loudspeakers in this layer with different first layer horizontal gains, e.g. by giving the object signal loudspeakers 14₁ to 14₅ such that it is amplitude panned to bottom layer, i.e. the first layer 15₁, see the panned first layer position 104′₁ in FIG. 2. At this horizontal panning, for example, for each loudspeaker of the first set of loudspeakers 14₁ to 14₅ a horizontal component gₙ^{horizontal} of the respective panning gain 41 is determined. Similarly, the object 104₁ is amplitude panned in the second layer 15₂ to the panned second layer position 104″₁ in FIG. 2. At this horizontal panning, for example, for each loudspeaker of the second set of loudspeakers 14₆ to 14₈ a horizontal component gₙ^{horizontal} of the respective panning gain 41 is determined. As can be seen, positions 104′₁ and 104″₁ may be selected so that they vertically overlay each other and/or so that the vertical projection of intended position 104₁ and the positions 104′₁ and 104″₁ coincide as well. FIG. 2 illustrates rendering the final object position 104₁ by applying amplitude panning between the layers 15, i.e. illustrates the vertical panning. Considering the virtual objects at positions 104′₁ and 104″₁ as virtual loudspeakers, amplitude panning by the gain determiner 40 is applied to render the virtual object at intended position 104₁, between the two layers 15₁ and 15₂. At this vertical panning, for example, for each loudspeaker of the first set of loudspeakers 14₁ to 14₅ and of the second set of loudspeakers 14₆ to 14₈ a vertical component gₙ^{vertical} of the respective panning gain 41 is determined. The result of this amplitude panning between the layers 15₁ and 15₂ are two gain factors, i.e. a horizontal component gₙ^{horizontal} and a vertical component gₙ^{vertical}, for each loudspeaker with which the respective loudspeaker signal is weighted, e.g., so that a sound source of the audio signal is panned to a desired audio signal's sound source position. This weighting for the horizontal panning between (real) loudspeaker layers 15 can additionally be frequency dependent to compensate for the effect that in vertical panning different frequency ranges may be perceived at different elevation.

In the following, the case of rendering an object in 3D is explained for an example case where an object 104₂ is panned above or below an outmost layer. An object may have a direction or position 104₂ which is not within the range of directions between two layers 15₁ and 15₂ as discussed with regard to the object position 104₁. An object's intended position 104₂, for example, is above or below a (physically present) layer 15, here below any available layer and, in particular, below the lower one, i.e. the first layer 15₁. As an example, the object has a direction/position 104₂ below the bottom loudspeaker layer, i.e. the first layer 15₁, of the loudspeaker setup which has been used as an example set-up in FIG. 2. In this case, horizontal amplitude panning is applied by the panning gain determiner 40 to the bottom layer to render the object 104₂ in that layer 15₁, see the resulting position 104′₂. The resulting position 104′₂ may represent a virtual source position corresponding to a projection of a desired audio signal's sound source position, see 104₂, onto the nearest loudspeaker layer, see 15₁. More generally speaking, a 2D amplitude panning is applied between the loudspeakers 14₁ to 14₅ attributed to a loudspeaker layer, i.e. the first layer 15₁, nearest to the object 104₂. At this horizontal panning, for example, for each loudspeaker of the first set of loudspeakers 14₁ to 14₅ a horizontal component gₙ^{horizontal} of the respective panning gain 41 is determined. Then a further amplitude panning is applied between the loudspeakers 14₁ to 14₅ attributed to the nearest loudspeaker layer, i.e. the first layer 15₁, along with a spectral shaping of the audio signal so as to result into a sound rendition by the loudspeakers 14₁ to 14₅ of the nearest loudspeaker layer, i.e. the first layer 15₁, which mimics sound from a further virtual source position 104″₂ offset from the nearest loudspeaker layer, i.e. the first layer 15₁, towards the desired audio signal's sound source position, see 104₂. Since there is no real loudspeaker at the vertical top or bottom direction, the vertical signal at 104″₂ may be equalized to mimic coloration of top or bottom sound respectively. The vertical signal is then given to the loudspeakers designated for top/bottom direction. In order to render the final object position 104₂ the panning gain determiner 40 may be configured to apply an even further amplitude panning between the virtual sound source position 104′₂ and the further virtual sound source position 104″₂, so as to determine second panning gains for a panning between the virtual sound source position 104′₂ and the further virtual sound source position 104″₂ so as to result into a rendering of the audio signal by the nearest loudspeaker layer's loudspeakers 14₁ to 14₅ from the desired audio signal's sound source position 104₂. The spectral shaping of the audio signal may be performed using a first equalizing function which mimics a timbre of bottom sound if the desired audio signal's sound source position 104₂ is positioned below to the one or more loudspeaker layers, i.e. below the first layer 15₁, and/or perform the spectral shaping of the audio signal using a second equalizing function which mimics a timbre of top sound if the desired audio signal's sound source position is positioned above the one or more loudspeaker layers, i.e. above the second layer 15₂.

FIG. 3 shows an embodiment of an audio processor 10 for performing audio rendering, see the audio renderer 11, by generating rendering parameters 100, which determine a derivation of loudspeaker signals 12 to be reproduced by a set of loudspeakers 14 from an audio signal 18. The focus of the embodiment shown in FIG. 3 lies on the gain determiner 40. Optionally, same may be combined with a delay determiner 50, as described with regard to FIG. 1. The embodiment shown in FIG. 3 provides details with regard to a determination of compensation gains 41 using the gain determiner 40. Same may represent the gains provided by the gain determiner shown in FIG. 1. Alternatively, each compensation gain 41 may represent a respective component of the respective gain to be applied to the respective loudspeaker, as described with regard to FIG. 1.

The gain determiner 40 is configured to perform a gain adjustment so as to determine, based on a listener position 31, the gains 41 for generating the loudspeaker signals 12 for the loudspeakers 14 from the audio signal 18. For example, gain adjustment in terms of adjusting gains associated with conditions of anechoic environments, so that an effect of reverberation is considered. Thus, the gains 41 determined by the gain determiner 40 are more suitable for real-world sound reproduction environments.

As depicted in FIG. 3, the gain determiner 40 of the audio processor 10 obtains reverberation effect information 110. The reverberation effect information 110 may indicate whether reverberation is effective in the reproduction space 112 and/or reverberation conditions in the reproduction space 112. The audio processor 10 may be configured to derive the reverberation effect information 110 from a bitstream or from side information of the bitstream.

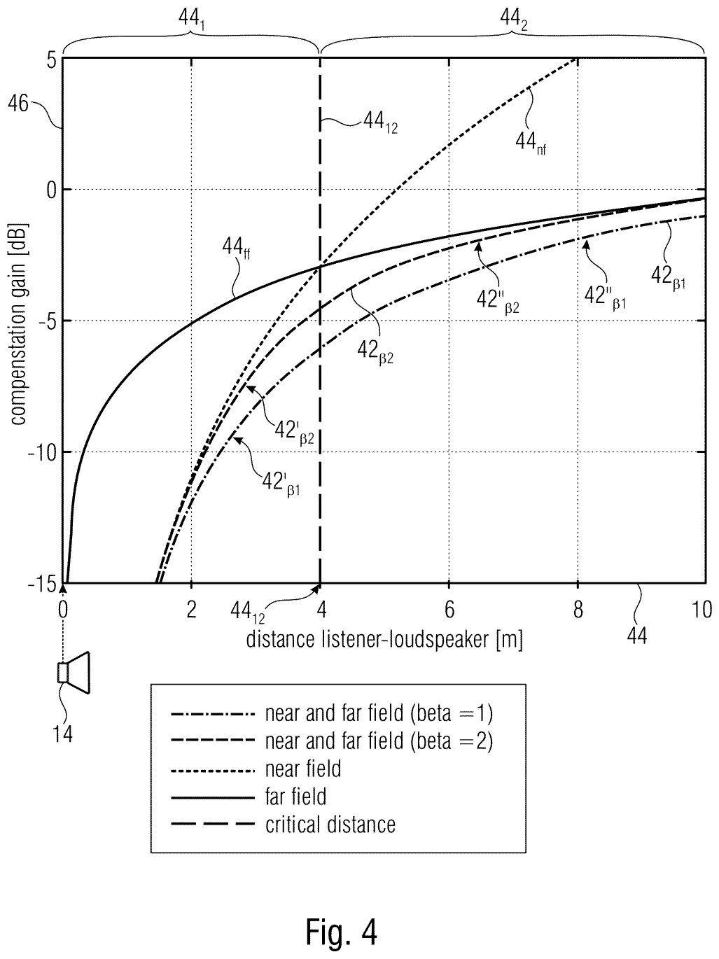

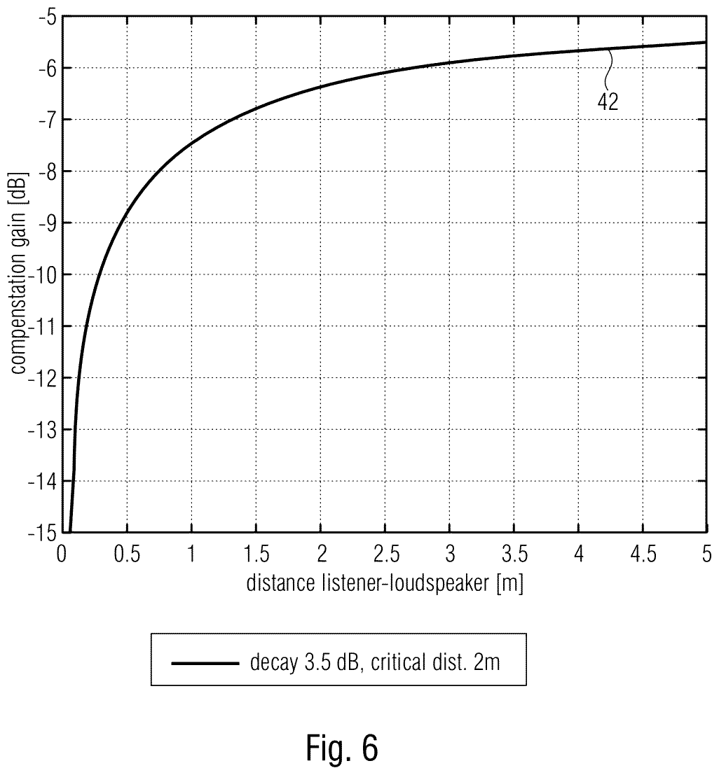

The audio processor 10 is configured to use, depending on the reverberation effect information 110, in the gain adjustment, for at least one loudspeaker 14, a roll-off gain compensation function 42 for mapping a listener-to-loudspeaker distance 44 of the at least one loudspeaker 14 onto a listener-to-loudspeaker-distance compensation gain 46 for the at least one loudspeaker 14, for which a compensated roll-off gets monotonically shallower with increasing listener-to-loudspeaker distance 44, see also FIG. 4 and FIG. 6. The audio processor 10, for example, is configured to determine, adapt or choose the roll-off gain compensation function 42 dependent on the reverberation effect information 110. The listener-to-loudspeaker-distance compensation gain 46 determined for the at least one loudspeaker 14 may represent a gain 41 provided to the audio renderer 11 for deriving a respective loudspeaker signal 12 to be reproduced by the respective loudspeaker 14 from the audio signal 18.

The listener position 31 may indicate for the at least one loudspeaker 14, for which the gain adjustment is used, a listener-to-loudspeaker distance 44. Alternatively, the listener position 31 may comprise for each loudspeaker 14 of the set of loudspeakers 14 a listener-to-loudspeaker distance 44. Alternatively, it is also possible that the listener position 31 indicates an absolute position of the listener 1 within the reproduction space 112. In this case, the audio processor 10 may be configured to additionally obtain information about the position of the at least one loudspeaker 14, for which the gain adjustment is used, within the reproduction space 112 or the positions of all loudspeakers 14. The audio processor 10 may be configured to determine for the at least one loudspeaker 14, for which the gain adjustment is used, the respective listener-to-loudspeaker-distance based on the listener position 31 and the position of the respective loudspeaker 14.

The roll-off gain compensation function 42 used by the gain determiner 40 will be described in more detail with regard to FIG. 4 (see 42_{β1} and 42_{β2}) and FIG. 6.

FIG. 4 shows schematically the roll-off gain compensation function for two different nearfield-farfield transition parameters beta, see 42_{β1} and 42_{β2}. The larger beta is, the faster is the transition between nearfield and farfield decay. The nearfield-farfield transition parameter beta may be comprised by the herein discussed reverberation effect information 110.

Both roll-off gain compensation functions 42_{β1} and 42_{β2} are exemplarily depicted for the same critical distance 44₁₂, e.g. a distance of four meter to the associated loudspeaker, i.e. to the loudspeaker to which the roll-off gain compensation functions may apply. The critical distance 44₁₂ may shift the roll-off gain compensation function along the listener-to-loudspeaker-distance axis, see 44. The larger the amount of reverberation is effective in the reproduction space, the smaller is the critical distance 44₁₂. FIG. 6 shows exemplarily a roll-off gain compensation function for a critical distance 44₁₂ of two meters. The critical distance 44₁₂ may be comprised by the herein discussed reverberation effect information 110. The critical distance 44₁₂ may represent a distance at which energy of direct sound is equal to energy of reverberant sound.

Further, a nearfield roll-off gain compensation function 43_{nf} and a farfield roll-off gain compensation function 43_{ff} are depicted. FIG. 4 shows compensation gain 46 versus the listener-to-loudspeaker distance 44.

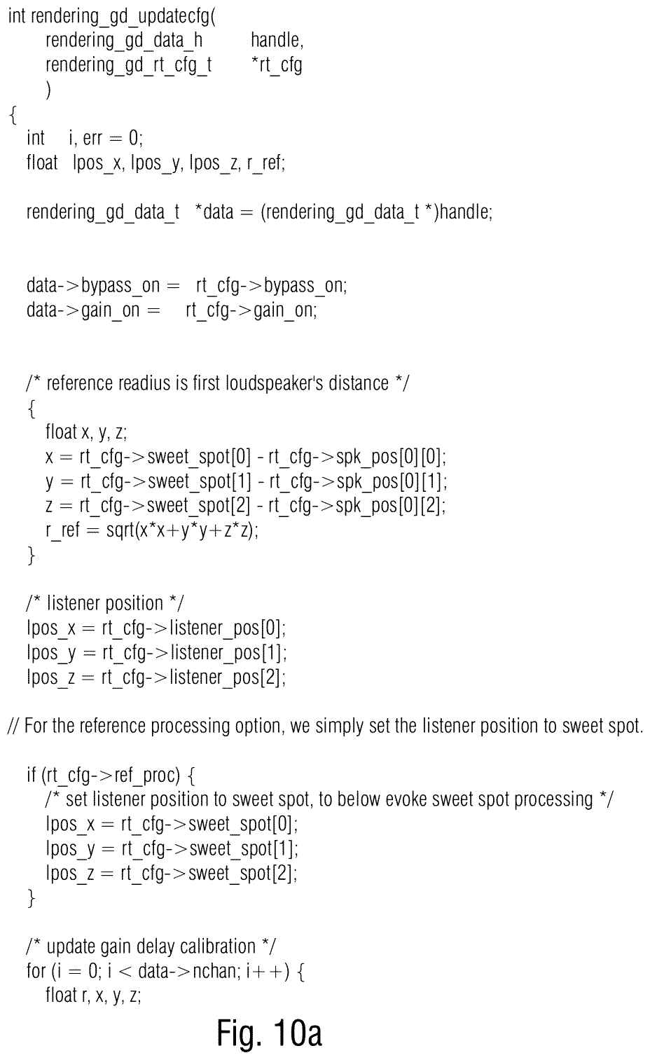

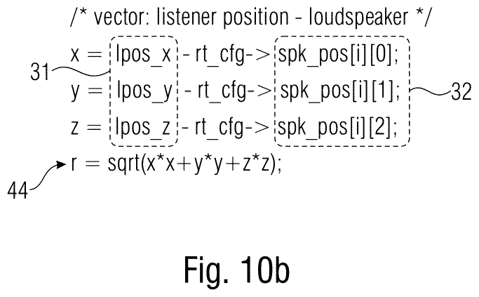

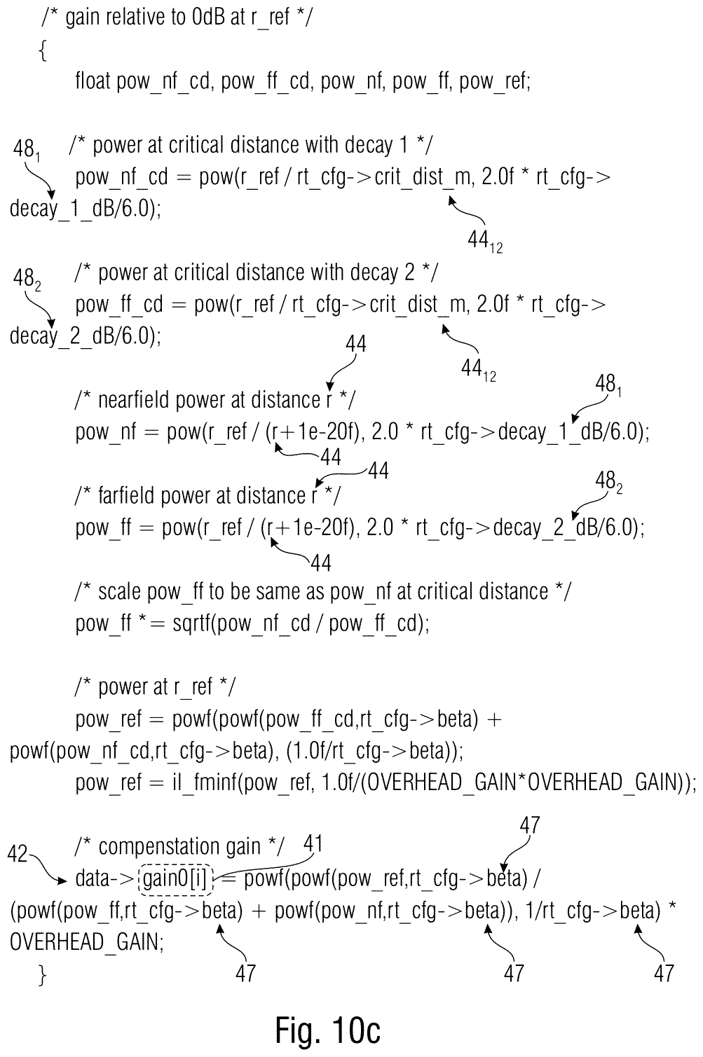

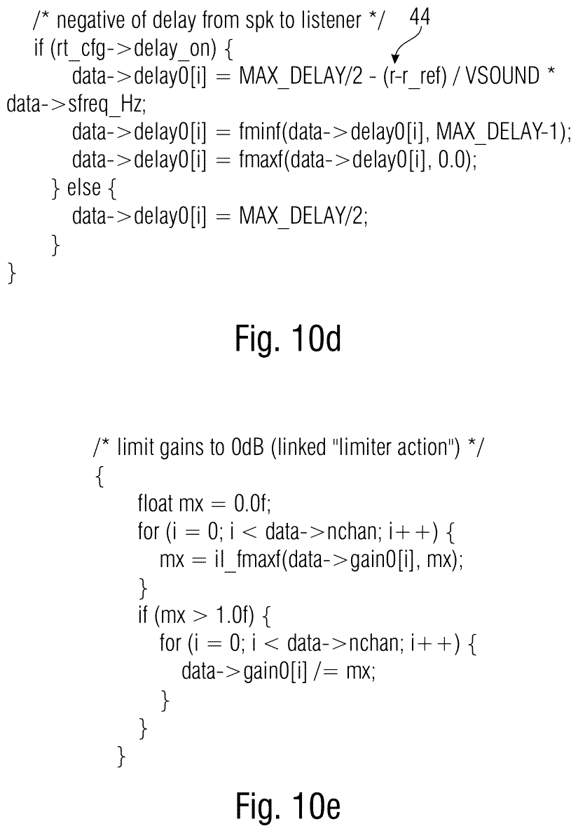

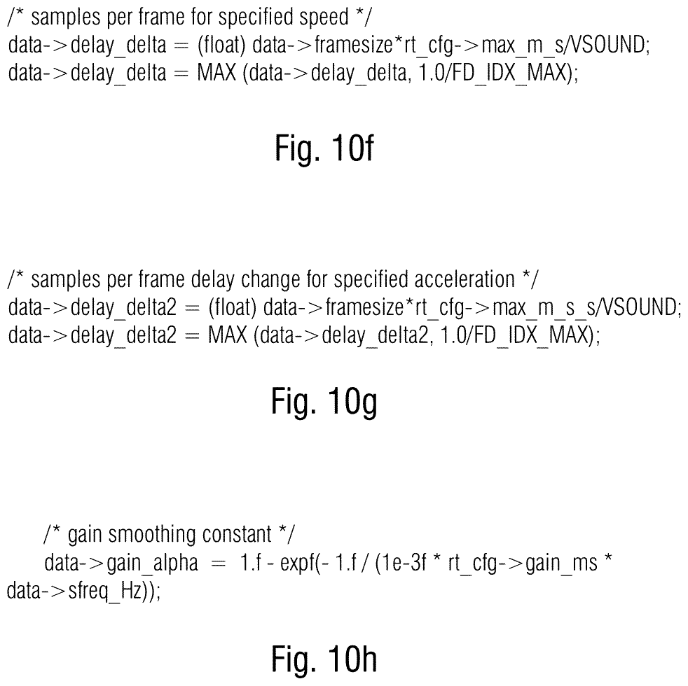

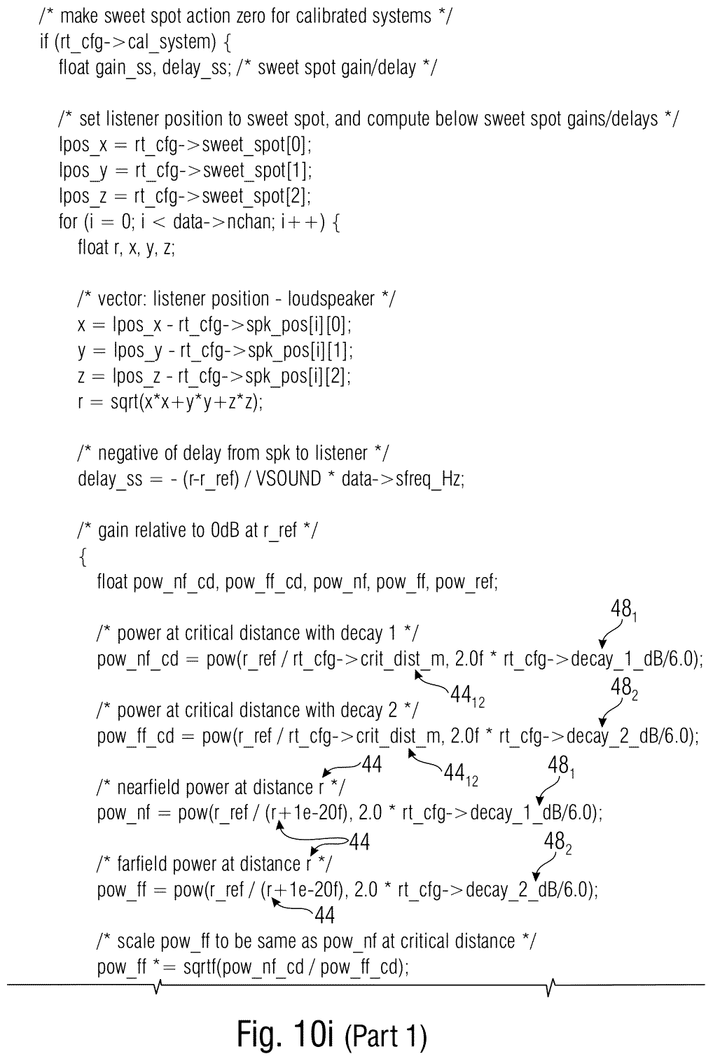

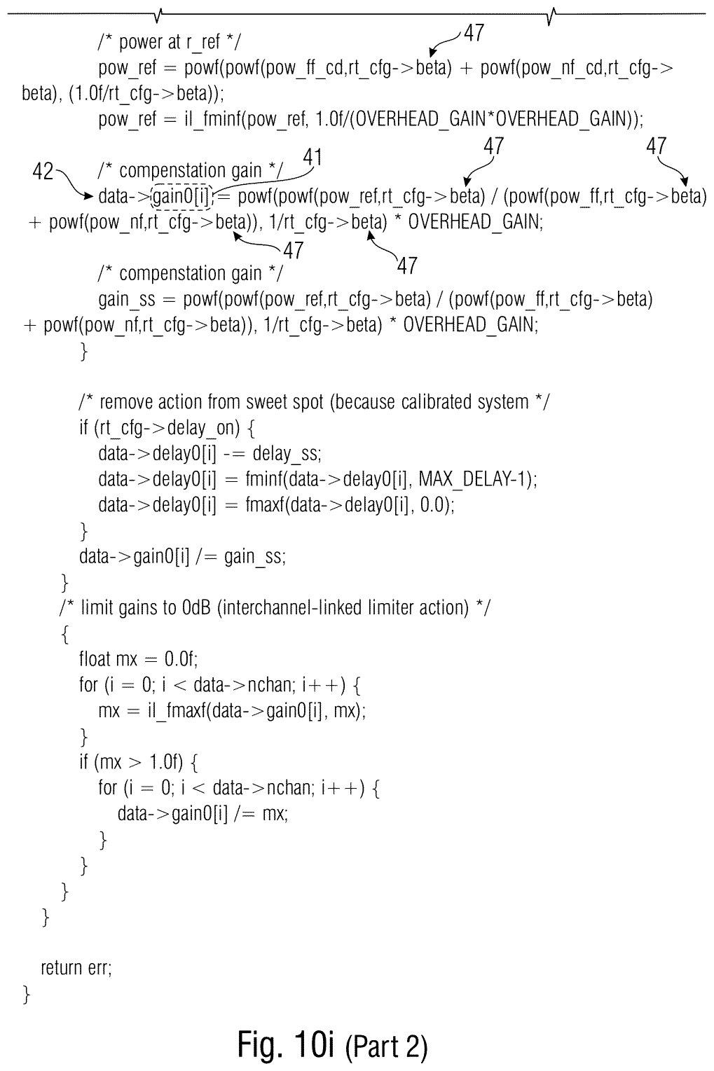

The reverberation effect information 110 may indicate that sound is decaying more slowly as the distance to a loudspeaker 14 increases. For example, near the respective loudspeaker 14, i.e. in a nearfield (see 44₁), sound energy rolls-off faster than away from the respective loudspeaker 14, i.e. in a farfield (see 44₂). The reverberation effect information 110 may comprise a nearfield decay parameter and a farfield decay parameter, e.g., see decay_1_dB and decay_2_dB in FIGS. 10c and 10i. The nearfield roll-off gain compensation function 43_{nf} indicates a compensation gain 46 for compensating a roll-off, i.e. a roll-off of sound energy, in accordance with the nearfield decay parameter, and the farfield roll-off gain compensation function 43_{ff} indicates a compensation gain 46 for compensating a roll-off, i.e. a roll-off of sound energy, in accordance with the farfield decay parameter. At the determination of the roll-off gain compensation function, see 42_{β1} and 42_{β2}, both, the nearfield decay parameter and the farfield decay parameter, are considered. The roll-off gain compensation function, see 42_{β1} and 42_{β2}, shows schematically a total compensation gain 46 for compensating a roll-off of sound energy over the listener-to-loudspeaker distance 44 in the nearfield and in the farfield. As can be seen in FIG. 4, the (e.g., total) roll-off gain compensation function, see 42_{β1} and 42_{β2}, transitions between the nearfield decay and the farfield decay.

The roll-off gain compensation function, see 42_{β1} and 42_{β2}, indicates the listener-to-loudspeaker-distance compensation gain 46, which is to be applied to a loudspeaker signal 12 to compensate a reverberation dependent roll-off of sound energy. As depicted in FIG. 4, the roll-off gain compensation function, see 42_{β1} and 42_{β2}, is configured such that the listener-to-loudspeaker-distance compensation gain 46 increases more slowly with increasing listener-to-loudspeaker distance 44, i.e. the roll-off gain compensation function 42 gets monotonically shallower with increasing listener-to-loudspeaker distance 44, e.g. a change of the compensation gain per unit distance decreases with increasing listener-to-loudspeaker distance 44.

The roll-off gain compensation function, see 42_{β1} and 42_{β2}, for example, has a first slope (see 42′_{β1} and 42′_{β2}), e.g. a first compensated roll-off slope, within a first distance zone 44₁, e.g., in the nearfield, and a second slope (see 42″_{β1} and 42″_{β2}), e.g., a second compensated roll-off slope, within a second distance zone 44₂, e.g., in the farfield, wherein the first slope 42₁ is larger than the second slope 42₂ and the first distance zone 44₁ relates to smaller distances than the second distance zone 44₂. The first slope 42₁ and/or the second slope 42₂ may be indicated by the reverberation effect information 110. The reverberation effect information 110 may further indicate a border distance, e.g. the critical distance 44₁₂, separating the first distance zone 44₁ and the second distance zone 44₂. The border distance 44₁₂ may correspond to a distance to the loudspeaker 14 at which an energy of direct sound is equal to an energy of reverberant sound within the reproduction space 112.

According to an embodiment, the reverberation effect information 110 may indicate for the roll-off gain compensation function 42 how same has to transition from the first distance zone 44₁ to the second distance zone 44₂, e.g. using the nearfield-farfield transition parameter beta. FIG. 4 shows exemplarily a roll-off gain compensation function 42_{β1} with a slower transition compared to the roll-off gain compensation function 42_{β2}. By being able to consider a reproduction space 112 specific transition between a nearfield sound energy decay and a farfield sound energy decay, an accuracy at the determination of compensation gains 41 can be increased.

The audio processor 10 is configured to perform the gain adjustment so that the listener position 31 becomes a sweet spot relative to the set of loudspeakers 14 in an acoustic or perceptual sense, i.e. the listener 1 perceives sound reproduced by the set of loudspeakers 14 as intended by the mixer. Artefacts possibly perceivable by the listener 1 at his position are reduced by the special gain adjustment.

In the following the relationship between the reverberation effect information 110 and the gain adjustment using the roll-off gain compensation function 42 is described in more detail in connection with FIGS. 3 and 4.

The reverberation effect information 110 may be indicative of an amount of reverberation effective in the reproduction room, i.e., the reproduction space 112, i.e., indicative of how much sound or signal is reflected, e.g, from walls or furniture, in the reproduction space 112. The amount of reverberation effective in the reproduction space 112 may indicate how much numerous reflections build up and then decay as the sound is absorbed, e.g., by surfaces of objects/walls in the reproduction space 112. In this case, the audio processor 10 may be configured to choose a roll-off gain compensation function, see 42 in FIG. 3 and 42_{β1} and 42_{β2} in FIG. 4 (in the following generally being referred to by using the reference numeral 42), or adapt a roll-off gain compensation function 42 to obtain a roll-off gain compensation function 42, for which an intensity at which the compensated roll-off gets monotonically shallower with increasing listener-to-loudspeaker distance 44 is the larger the larger the amount of reverberation effective in a reproduction space 112 is. FIG. 4 shows exemplarily a roll-off gain compensation function 42_{β1} for a reproduction space 112 with a greater amount of reverberation effective compared to a reproduction space 112 associated with the roll-off gain compensation function 42_{β2}. The roll-off gain compensation function 42_{β1} can be used to compensate a roll-off of sound energy for a reproduction space 112 in which sound energy does not roll-off or wear off so quickly as at a reproduction space 112 with less amount of reverberation effective, compare with the roll-off gain compensation function 42_{β2} for a reproduction space 112 with less amount of reverberation effective. Therefore, the roll-off gain compensation function should be adapted or chosen by the audio processor 10, so that the listener-to-loudspeaker-distance compensation gain 46 starts to increase more slowly with increasing listener-to-loudspeaker distance 44 at a gain (see the critical distance 44₁₂) being smaller the larger the amount of reverberation is effective in the reproduction space 112. This is based on the realization that an increasing amount of reverberation effective in the reproduction space 112 decreases a roll-off of sound energy. This adaptation of the roll-off gain compensation function 42 allows to increase an accuracy at a determination of compensation gains 41.

The reverberation effect information 110 may be indicative of whether reverberation is effective in the reproduction space 112, or not. The herein described roll-off gain compensation functions 42, which increases monotonically shallower/slower with increasing listener-to-loudspeaker distance 44, may only be used if reverberation is effective in the reproduction space 112. If the reverberation effect information 110 indicates that reverberation is not effective in the reproduction space 112, the audio processor 10 may be configured to use a further roll-off gain compensation function for which the compensated roll-off is constant, e.g. the nearfield roll-off gain compensation function 43_{nf} may be used in this case. For example, the further roll-off gain compensation function may be configured to compensate a predefined roll-off of acoustic energy, e.g., 6 dB, per doubling of the listener-to-loudspeaker distance 44. Reverberation may result in a different decay of sound energy in a nearfield of a loudspeaker 14 compared to a farfield of a loudspeaker. However, it is not necessary to consider this differentiation between nearfield and farfield, if no reverberation is effective in the reproduction space 112. Therefore, a simpler determination of the compensation gain can be performed for such cases. This enables to efficiently and with reduced complexity determine compensation gains for different reproduction spaces 112.

An idea of the underlying embodiments of the present invention is described subsequently. In particular, a distance gain compensation, see the roll-off gain compensation function 42 in FIG. 3 and 42_{β1} and 42_{β2} in FIG. 4, is provided that considers the fact that there is reverberant energy in the reproduction room 112 and thus the acoustic energy rolls off more slowly with growing distance between the loudspeaker location and the listener 1. I.e., the gain/level adjustment is performed considering information about the amount of reverb present in the reproduction room 112. As an example, the theoretical roll-off (“slope”) of the acoustic energy over distance would be 6 dB per distance doubling for an acoustic point source. By considering the reverberation in the room, the strength (slope) of the gain compensation for user-adaptive loudspeaker rendering becomes more shallow (less steep) with increasing distance, see FIGS. 4 and 6. One parameter for defining this change in roll-off can be related to the so-called ‘critical distance’ or border distance 44₁₂ that is known from acoustics as the distance at which the energy of the direct sound is equal to the energy of the reverberant sound [4]. For the user-adaptive loudspeaker rendering scheme, a control parameter related to the critical distance 44₁₂ is very effective to control the proper compensation characteristics.

Thus, the above thoughts result, according to an embodiment, into an audio signal processor 10
Wherein the value of the gain compensation slope for at least one loudspeaker signal depends on the location of the listener/the listener's distance 44 from this loudspeaker
   Optionally, also the delay can be adjusted in accordance with the data about the reverberation in the reproduction environment room 112
Wherein the slope is smaller (shallower) for larger distances than for smaller distances
Wherein there are at least two distance zones 44₁ and 44₂ for which different slope values or slope value ranges are applied and the slope value for the nearby (first) zone 44₁ is larger than that of the distant (second) zone 44₂.
   Wherein a parameter related to ‘critical distance’ 44₁₂ is used to define the border between a near (first) and a distant (second) zone
   Wherein the slope value of the nearly (first) zone 44₁ is steeper than that of the distant (second) zone 44₂.
   Wherein a slope parameter for a near (first) zone 44₁ is used/accepted and applied in this zone
   Wherein a slope parameter for a distant (second) zone 44₂ is used/accepted and applied in this zone
   Wherein optionally a transition parameter determining the transition (e.g. roundness) between these two zones 44₁ and 44₂ is defined and applied to the roll-off gain compensation function 42

An embodiment according to this invention is related to an audio processor 10 configured for generating, for each of a set of one or more loudspeakers 14, a set of one or more parameters (this can, for example, be parameters, which can influence the delay, level or frequency response of one or more audio signals, e.g., the rendering parameters 100), which determine a derivation of a loudspeaker signal 12 to be reproduced by the respective loudspeaker 14 from an audio signal 18, based on a listener position 31 (the listener position 31 can, for example, be the position of the whole body of the listener 1 in the same room, i.e. the reproduction space 112, as the set of one or more loudspeakers 14, or, for example, only the head position of the listener 1 or also, for example, the position of the ears of the listener 1. The listener position 31 can, for example, be a position in reference to the set of one or more loudspeakers 14, for example, a distance of the listener's head to the set of one or more loudspeakers 14) and loudspeaker position of the set of one or more loudspeakers 14. The audio processor 10 is configured to base the generation of the set of one or more parameters for the set of one or more loudspeakers 14 on information about the reverberation characteristics, i.e. reverberation effect information 110, of the reproduction environment (room). Specifically, the computation of the level (gain 41) value for loudspeaker signals 12 is based on information about the level of reverberant sound present in the reproduction room 112.

Considering this information about the level reverberant sound, the invention achieves improved rendering results by utilizing a strength (slope) of the level (gain 41) compensation for user-adaptive loudspeaker rendering that becomes more shallow (less steep) with increasing distance, i.e. listener-to-loudspeaker distance 44. One important parameter for defining this change in the distance dependent slope can be related to the so-called ‘critical distance’, see 44₁₂. The term ‘critical distance’ 44₁₂ is known from acoustics as the distance at which the energy of the direct sound radiated from a sound source is equal to the energy of the reverberant sound [4]. For the inventive user-adaptive loudspeaker rendering scheme, a control parameter related to the critical distance 44₁₂ is found to be very effective to control the proper compensation characteristics. Furthermore, a slope value for listener positions 31 clearly below the critical distance 44₁₂ can be defined and used, as well as a slope value for listener positions 31 clearly beyond the critical distance 44₁₂.

This can be realized with the audio processor 10. The audio processor 10 gets, for example, information about the listener positioning, i.e. the listener position 31, the loudspeaker positioning, i.e. the loudspeaker position, and the reverberation characteristics, i.e. the reverberation effect information 110, of the reproduction room, such as, for example, the room's critical distance, a near-by slope parameter (e.g., indicating the first slope 42₁), or a for-off slope parameter (e.g., indicating the second slope 42₂). The audio processor 10 can calculate from this information a set of one or more parameters. With the set of one or more parameters, the input audio, alternatively speaking of the incoming audio signal 18, can be modified. With this modification of the audio signal 18, the listener 1 receives at his position an optimized audio signal. With this optimized signal, the listener 1 can, for example, have in his position nearly or completely the same hearing sensation as it would be in the listener's ideal listening position. The ideal listener position is, for example, the position at which a listener experiences an optimal audio perception without any modification of the audio signal, like a sweet spot. This means, for example, that the listener 1 can perceive at this position the audio scene in a manner intended by the production site. The ideal listener position can correspond to a position equally distant from all loudspeakers 14 (one or more loudspeakers 14) used for reproduction.

Therefore, the audio processor 10 according to the present invention allows the listener 1 to change his/her position to different listener positions 31 and have at each, at least at some, positions the same, or at least partially the same, listening sensation as the listener would have in his ideal listening position.

In summary, it should be noted that the audio processor 10 is able to adjust at least one of delay, level or frequency response of one or more audio signals 18, based on the listener positioning, loudspeaker positioning and/or the loudspeaker characteristic, with the aim of achieving an optimized audio reproduction for at least one listener 1. The level is adjusted also in response to information about the reverberation characteristics 110 of the reproduction room 112.

Now, an embodiment of the present invention is described, here for adaptive loudspeaker rendering.

General notes shall be made at the beginning. As an alternative to rendering and binauralizing MPEG-I scenes to headphones, the playback over loudspeakers is specified. In this operation mode, the MPEG-I Spatializer (HRTF based renderer) is replaced with a dedicated loudspeaker-based renderer which is explained below.

For a high quality listening experience, loudspeaker setups assume the listener 1 to be situated in a dedicated fixed location, the so-called sweep spot. Typically, within a 6 DOF playback situation, the listener 1 is moving. Therefore, the 3D spatial rendering has to be instantly and continuously adapted to the changing listener position 31. This may be achieved in two hierarchically nested technology levels:
1. Gains 41 and delays 51, for example, are applied to the loudspeaker signals 12 such that at the loudspeaker signals 12 reach the listener position 31 at a similar gain and delay, i.e. so that same lies in the sweet spot. Optionally a high shelving compensation filter is applied to each loudspeaker signal 12 related to the current listener position 31 and the loudspeakers' orientation with respect to the listener 1. This way, as a listener 1 moves to positions off-axis for a loudspeaker 14 or further away from it, high frequency loss due to the loudspeaker's radiation high-frequency pattern is compensated.
2. Due to the 6 DoF movement, the angles between loudspeakers 14, objects and the listener 1 change as a function of listener position 31. Therefore, a 3D amplitude panning algorithm, see FIG. 2, for example, is updated in real-time with the relative positions and angles of the varying listener position 31 and the fixed loudspeaker configuration as set in the LSDF. All coordinates (listener position 31, source positions) may be transformed in the listening room coordinate system, i.e. into the coordinate system of the reproduction space 112.

### Physical Compensation Level (Level 1)

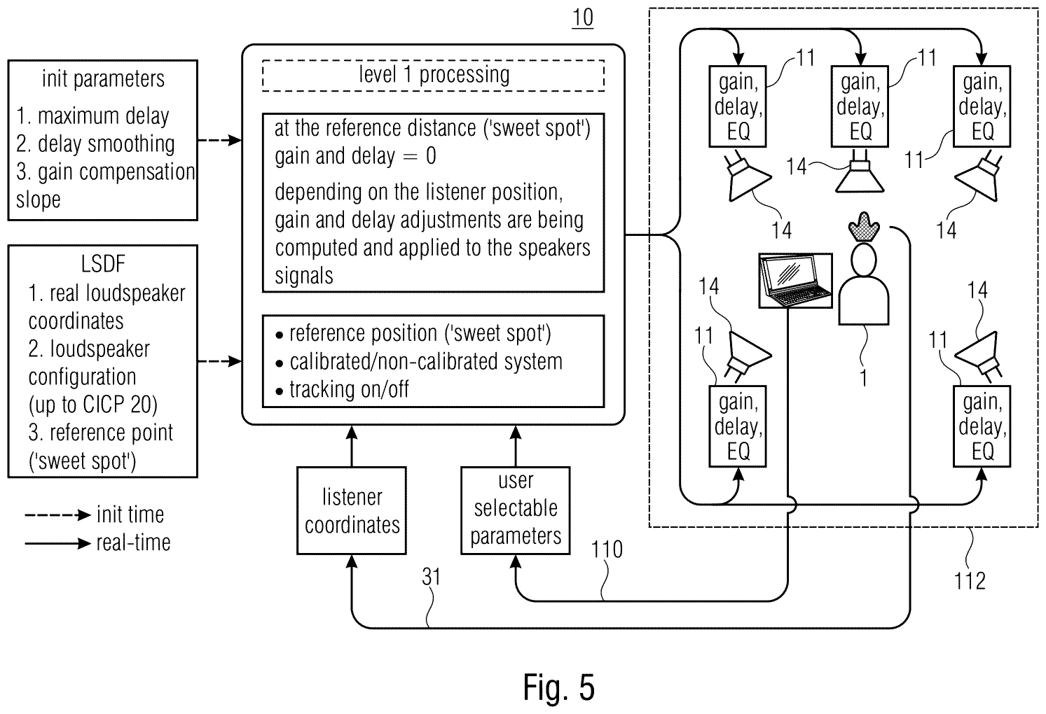

FIG. 5 shows an overview of an embodiment of a Level 1 system 10 with its main components and parameters. The audio processor 10 described with regard to FIGS. 1 to 4 may comprise features and or functionalities as described with regard to the embodiment of FIG. 5.
Level 1: real-time updated compensation of loudspeaker (frequency-dependent) gain & delay, see the audio renderer 11, enables ‘enhanced rendering of content’. By exploiting the tracked user position information, e.g. a version of the listener position 31, the listener 1, i.e. user, can move within a large “sweet area” (rather than a sweet spot) and experience a stable sound stage in this large area when, for example, listening to legacy content (e.g. stereo, 5.1, 7.1+4H). For immersive formats (i.e., not for stereo), the sound seems to detach from the loudspeakers 14 rather than collapse into the nearest speakers 14 when walking away from the sweet spot, i.e. a quality somewhat close to what is known from wavefield synthesis, but for a single-user experience. For stereo reproduction, the technology offers left-right sound stage stability for a wide range of user positions 31 (i.e. the range between the left and right loudspeakers at arbitrary distance).

The gain compensation in Level 1, for example, is based on an amplitude decay law. In free field, the amplitude is proportional to 1/r, where r is the distance from the listener 1 to a loudspeaker 14 (1/r corresponds to 6 dB decay per distance doubling). In a room 112, due to the presence of acoustic reflections and reverberation, sound is decaying more slowly as the distance to a loudspeaker 14 increases. Therefore nearfield decay, farfield decay, and/or critical distance parameters, e.g. comprised by reverberation effect information 110, may be used to specify decay rate as a function of distance to a loudspeaker 14. Additionally there might be a nearfield-farfield transition parameter beta, e.g. comprised by reverberation effect information 110. The larger beta is, the faster is the transition between nearfield and farfield decay. FIG. 6 shows an example of a gain compensation as a function of distance, i.e. a roll-off gain compensation function 42 usable by the gain determiner 40. In the reverberant field, the gain change is smaller than in the free-field.

The delay compensation in Level 1, for example, computes the propagation delay from each loudspeaker 14 to the listener position 31 and then applies a delay to each loudspeaker 14 to compensate for the propagation delay differences between loudspeakers 14. Delays may be normalized (offset added or subtracted) such that the smallest delay applied to a loudspeaker signal 12 is zero.

### Object Rendering Level (Level 2)

Level 2: user-tracked object panning enables rendering of point sources (objects, channels) within the 6 DoF play space and needs Level 1 as a prerequisite. Thus, it addresses the use case of ‘6 DoF VR/AR rendering’. The following features and/or functionalities can additionally be comprised by the Level 1 system 10.

A 3D amplitude panning algorithm may be used which works in loudspeaker layers, e.g. horizontal and height layers, e.g., as described with regard to FIG. 2. Each layer may apply a 2D panning algorithm for the projection of the object onto the layer. The final 3D object is rendered by applying amplitude panning between the two virtual objects from the 2D panning in the two layers.

When an object is located above the highest layer, then 2D panning is applied in that layer. The final 3D object is rendered by applying amplitude panning between the virtual object from the 2D panning and an (non-existent) object in an upper vertical direction. The signal of the vertical object may be equalized to mimic timbre of top sound and equally distributed to the loudspeakers of the highest layer.

When an object is located below the lowest layer, then 2D panning is applied in that layer. The final 3D object is rendered by applying amplitude panning between the virtual object from the 2D panning and an (non-existent) object in an below vertical direction. The signal of the vertical object may be equalized to mimic timbre of bottom sound and equally distributed to the loudspeakers of the lowest layer.

The vertical panning as described, is equally applicable to loudspeaker setups with one layer such as 5.1 and with multiple layers such as 7.4.6.

Levels 1 and 2 applied to object rendering faithfully renders MPEG-I scenes like over headphones. This is of great benefit, compared to loudspeaker rendering MPEG-I content without applying adaptive tracking (1 and 2).

### Physical Compensation Level (Level 1)

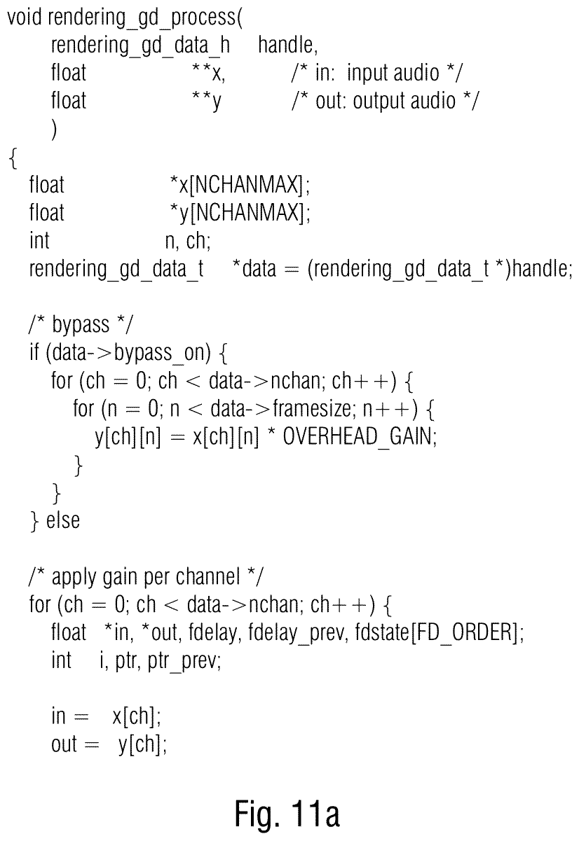

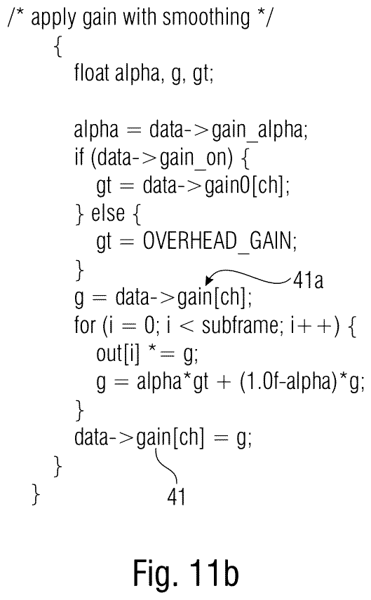

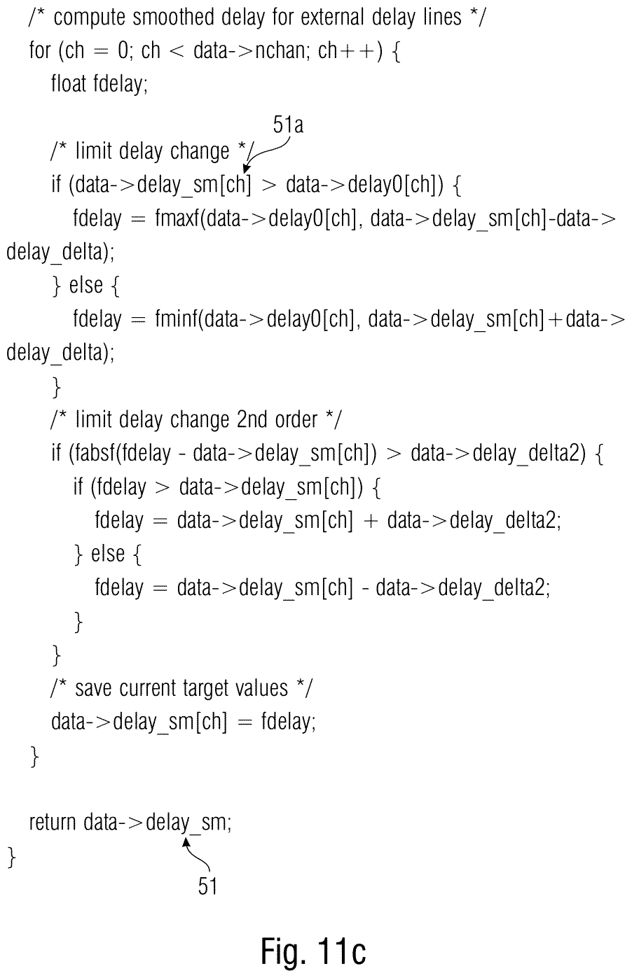

In the following an embodiment of gain and delay adjustment based on a listener position is described using code snippets, see FIGS. 10c to 10i and FIG. 11b and FIG. 11c. Features and/or functionalities described in the following with regard to the gain and/or delay adjustment may be comprised by the audio processor 10 of FIG. 1 or by the Level 1 system 10 of FIG. 5. The audio processor 10 of FIG. 3 may additionally comprise features and/or functionalities described in the following with regard to the gain adjustment. Optionally, the audio processor 10 of FIG. 3 may comprise features and/or functionalities described in the following with regard to the gain and/or delay adjustment. Optionally, the audio processor 10 of FIG. 1, the audio processor 10 of FIG. 3 and the audio processor 10 of FIG. 3 may comprise further features and/or functionalities as described below.

### Data Elements and Variables

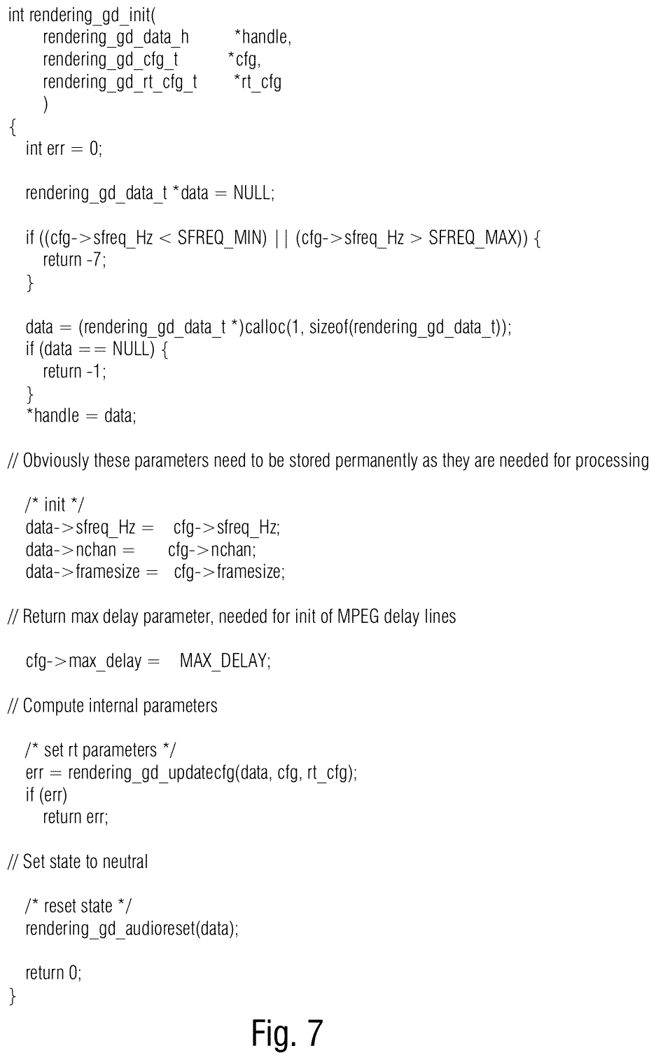

Definitions and/or explanations of data elements and variables used in the following, see FIGS. 7 to 11c, are provided:
SFREQ_MIN minimum sample rate [Hz]=44100
SFREQ_MAX maximum sample rate [Hz]=48000
VSOUND speed of sound in air [m/s]=340.0
MAX DELAY maximum delay [samples]=960
OVERHEAD_GAIN overhead [lin]=0.25
framesize number of samples per frame, default: 256
sfreq_Hz sampling frequency of input audio, default: 48000
nchan number of channels (loudspeakers)
max_delay maximum delay [samples], default: MAX_DELAY
bypass_on 0: normal operation, 1: bypass, default: 0
ref_proc 0: normal operation, 1: processing like for sweet spot, default: 0
cal_system 0: normal operation, 1: calibrated system, default: 0
gain_on 0: gain off, 1: on, default: 1
delay_on 0: delay off, 1: on, default: 1
decay_1_dB nearfield sound decay per distance doubling [dB], default: 8
decay_2_dB farfield sound decay per distance doubling [dB], default: 0
beta 1: default nearfield-farfield transition, >1 faster transition
crit_dist_m critical distance [m], default: 4
max_m_s maximum movement velocity [v in m/s], default: 1
max_m_s_s maximum movement acceleration [a in m/s], default: 1
gain_ms gain smoothing time constant [ms], default: 40
sweet_spot sweet spot position [m,m,m]
spk_pos loudspeaker coordinates [m,m,m]
listener_pos listener coordinates [m,m,m]

All coordinates, for example, are relative to the listening room as defined in the LSDF file.

These parameters may be stored in the following structures:

### Public Data Structures

| typedef struct rendering_gd_cfg { | |
|---|---|
| int | framesize; |
| float | sfreq_Hz; |
| int | nchan; |
| float | max_delay; |
| } rendering_gd_cfg_t; | |
| typedef struct rendering_gd_rt_cfg { | |
| int | bypass_on; |
| int | ref_proc; |
| int | cal_system; |
| int | gain_on; |
| int | delay_on; |
| float | decay_1_dB; |
| float | decay_2_dB; |
| float | crit_dist_m; |
| float | beta; |
| float | max_m_s; |
| float | max_m_s_s; |
| float | gain_ms; |
| float | sweet_spot[3]; |
| float | spk_pos[NCHANMAX][3]; |
| float | listener_pos[3]; |

} rendering_gd_rt_cfg_t;

Internal parameters that are calculated from the above listed parameters and states, for example, are stored in the following structure:

### Internal Data Structure

| typedef struct { | |
|---|---|
| /* static parameters */ | |
| float | sfreq_Hz; |
| int | nchan; |
| int | framesize; |
| /* real-time parameters */ | |
| int | bypass_on; |
| int | gain_on; |
| float | delta_gi; |
| float | delta_gd; |
| float | gain_alpha; |
| float | delay_delta; |
| float | delay_delta2; |
| /* state */ | |
| float | delay0[NCHANMAX]; |
| float | delay[NCHANMAX]; |
| float | gain0[NCHANMAX]; |
| float | gain[NCHANMAX]; |

} rendering_gd_data_t;

### Stage Description

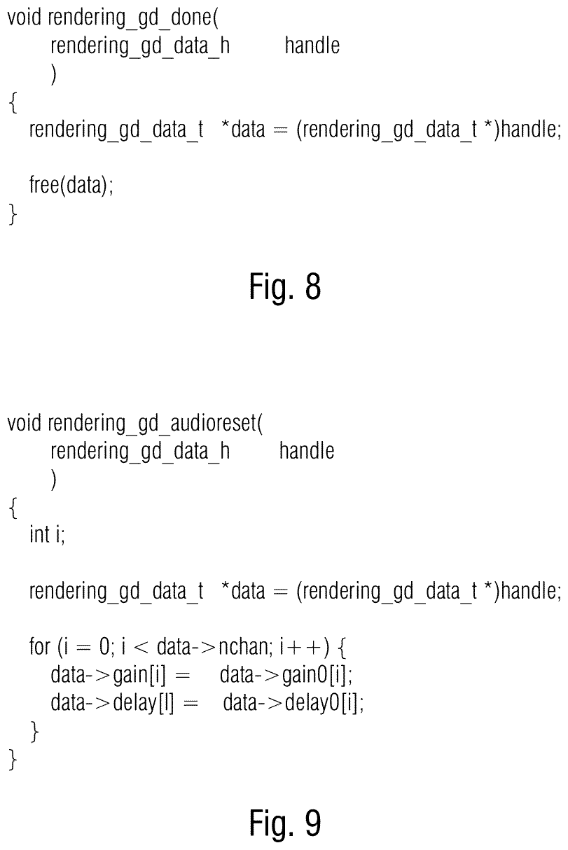

The embodiment of gain and delay adjustment based on a listener position is described in the following using code snippets associated with different stages. The embodiment may comprise an initialization stage (see FIG. 7), a release stage (see FIG. 8), a reset stage (see FIG. 9), a real-time parameters update stage (see FIGS. 10a to 10i), and an audio processing stage (see FIGS. 11a to 11c). The audio processor 10 of FIG. 1, the Level 1 system 10 of FIG. 5 and the audio processor 10 of FIG. 3 may comprise features and/or functionalities described with regard to one or more of the stages or individual features and/or functionalities of one or more stages.

### Initialize

FIG. 7 shows exemplarily a code snippet of the initialization stage.

The loudspeaker setup may be loaded from a LSDF file.

A structure of type rendering_gd_cfg_t is initialized with default values and the nchan field is set to the number of loudspeakers in the loudspeaker setup.

A structure of type rendering_gd_rt_cfg_t is initialized with default values. The loudspeaker positions from the LSDF file are stored in the field spk_pos. If the ReferencePoint element was given in the LSDF file, its coordinates are stored in the field sweet_spot. The field cal_system is set to the value of the attribute calibrated if present.

The aforementioned structures are passed to the rendering_gd_init function.

### Release

FIG. 8 shows exemplarily a code snippet of the release stage.

### Reset

FIG. 9 shows exemplarily a code snippet of the reset stage. FIG. 9 shows that all internal buffers are flushed.

### Update Real-Time Parameters

In the update thread, the virtual listener position is transformed into the listening room coordinate system. This is only relevant for VR scenes, in AR scenes the two coordinate systems coincide.

All further processing happens in the audio thread.

The structure of type rendering_gd_rt_cfg_t is updated by setting the listener pos field to the listener position (in the listening room coordinate system), see FIG. 10a. The structure is then passed to the rendering_gd_updatecfg function, see FIG. 10a.

For each loudspeaker the compensation gain and delay is computed. The reference distance r_ref (computed in FIG. 10a) is the distance at which gain and delay compensation are zero (dB, samples). Based on the loudspeaker's distance to listener r and reference distance r_ref, gain and delay compensation are computed. The computation of the listener-to-loudspeaker distance 44 based on the listener position 31 and the respective loudspeaker position 32 is shown in FIG. 10b. The listener-to-loudspeaker distance 44 may represent a version of the listener position 31.

In freefield sound decays by 6 dB per distance doubling. In a room, decay can be approximated by using less decay, e.g. 4 dB per distance doubling. Alternatively, one can consider critical distance (hall radius). When one is near a loudspeaker, decay is decay_dB per distance doubling. Beyond the critical distance crit_dist_m sound is only decaying slowly. It is proposed to use a roll-off gain compensation function 42 (see FIG. 6 and FIG. 10c and FIG. 10i) for determining gain compensation that compensates gain changes due to the described sound decay.

The gain compensation may be based on an amplitude decay law. In free field, the amplitude is proportional to 1/r, where r is the distance from the listener to a loudspeaker (1/r corresponds to 6 dB decay per distance doubling). In a room, due to the presence of acoustic reflections and reverberation, sound is decaying more slowly as the distance to a loudspeaker increases. Therefore nearfield decay, farfield decay, and critical distance parameters may be used to specify decay rate as a function of distance to a loudspeaker. Additionally there is a nearfield-farfield transition parameter beta 47. The larger beta is, the faster is the transition between nearfield and farfield decay. The roll-off gain compensation function 42 may depend on the nearfield-farfield transition parameter beta 47. The nearfield-farfield transition parameter beta 47 may define how fast the roll-off gain compensation function 42 transition between nearfield and farfield, i.e. how fast the roll-off gain compensation function 42 transitions from a steep increase of compensation gain per listener-to-loudspeaker distance 44 to a shallow/slight increase of compensation gain per listener-to-loudspeaker distance 44.

Note that the circumstance that the compensated roll-off gets monotonically shallower with increasing listener-to-loudspeaker distance 44, may be embodied by the slope of the compensated roll-off energy, when measured in logarithmic domain, monotonically decreasing with increasing listener-to-loudspeaker distance 44.

The roll-off gain compensation function 42 maps the listener-to-loudspeaker distance 44 associated with a loudspeaker onto a listener-to-loudspeaker-distance compensation gain 41 for the loudspeaker associated with the listener-to-loudspeaker distance 44. The roll-off gain compensation function 42 may be configured to compensate a roll-off that gets monotonically shallower with increasing listener-to-loudspeaker distance 44. As noted above, in reproduction spaces, in which reverberation is effective, sound energy may decay in the nearfield differently than in the farfield. Therefore, it is proposed to use a first decay parameter 481, see decay_1_dB, for the nearfield, i.e. a first distance zone, and a second decay parameter 482, see decay_2_dB, for the farfield, i.e. a second distance zone, wherein first distance zone is associated with smaller listener-to-loudspeaker distances 44 than the second distance zone. As can be seen in FIG. 10c and FIG. 10i the roll-off gain compensation function 42 considers the different decays 48₁ and 48₂ for the nearfield and the farfield at the determination of the compensation gain 47 for a certain listener-to-loudspeaker distance 44. For example, the roll-off gain compensation function 42 may consider how much sound energy decayed at the listener-to-loudspeaker distance 44 according to the first decay parameter 481, see pow_nf, and according to the second decay parameter 48₂, see pow_ff. A critical distance 44₁₂ separates the nearfield and the farfield. The sound energy decaying according to the second decay parameter 48₂, see pow_ff, may be scaled, so that a decay of sound energy according to the first and second decay parameter 48₁ and 48₂ is equal at the critical distance 44₁₂. The a first decay parameter 48₁ may indicate a faster decay of sound energy as the second decay parameter 48₂. Therefore, for the roll-off gain compensation function 42 the compensated roll-off gets monotonically shallower with increasing listener-to-loudspeaker distance 44.

Further, the roll-off gain compensation function 42 may consider how much sound energy decayed at the sweet spot, see pow_ref at the sweet spot r_ref. Thus, the gain adjustment is performed, so that the listener position becomes a sweet spot relative to the set of loudspeakers in an acoustic or perceptual sense. The sound energy decayed at the sweet spot may be determined considering both the first and second decay parameter 48₁ and 48₂.

Depending on distance 44 of loudspeaker to listener position, sound transmission time is varying. These variations may be compensated by applying delays. An offset MAX_DELAY/2, for example, is added to the compensation delays, such that they are positive, see FIG. 10d. Further, the listener-to-loudspeaker distance may be considered at the delay determination/adjustment together with a distance between the sweet spot and the respective loudspeaker, see r_ref. Thus, the delay processing is performed, so that the listener position becomes a sweet spot relative to the set of loudspeakers in an acoustic or perceptual sense.

FIG. 10d shows that for each loudspeaker, a distance 44 of the listener position to a position of the respective loudspeaker may be determined and, based on the distance 44, the delay, see delay0 [i], for the respective loudspeaker may be determined.

As can be seen in FIG. 10d, for each loudspeaker a separate delay, e.g., an absolute delay, is determined, see the index i of the delay variable delay0. Alternatively, the delay processing may determine a reference loudspeaker among the set of loudspeakers and determe the delays of the loudspeakers other than the reference loudspeaker relative to the delay determined for the reference loudspeaker.

An overhead can be used, determined by OVERHEAD_GAIN, see FIG. 10e. That is, this system can amplify signals, when a listener is far away from a loudspeaker up to a factor of 1/OVERHEAD_GAIN. Should the gains supersede this value, then all gains across the channels are scaled with the same factor such that the largest gain is 1.0 (0 dB). This corresponds to inter-channel linked limiter action.

Apart from gain adjustment, additionally, or alternatively, a delay adjustment may be performed, so as to reduce artifacts in the audio rendition due to changes in the delays.

According to an embodiment, a control of delay processing may be performed by subjecting a listener's velocity to a clipping or by subjecting a delay to a clipping, wherein the clipping of the delay and the listener's velocity may be controlled based on a maximum allowable listener velocity, see max_m_s. For example, a maximal velocity may be defined, for which nearly no artifacts result in the audio rendition due to changes in the delays due to a too fast change of a position by a listener. FIG. 10f shows a determination of a maximum delay change, see delay_delta, based on a maximum allowable listener velocity. A number of samples the delay is allowed to change from frame to frame is computed as a function of maximum allowed movement velocity max_m_s. The maximum allowed movement velocity max_m_s may correlate with a maximum rate of delay change [v in m/s].

According to an alternative embodiment, a control of delay processing may be performed by subjecting a listener's acceleration to a clipping or by subjecting a temporal rate of change of a delay to a clipping, wherein the clipping of the temporal rate of change of the delay and the listener's acceleration may be controlled based on a maximum allowable listener acceleration, see max_m_s_s. For example, a maximal acceleration may be defined, for which nearly no artifacts result in the audio rendition due to changes in the delays due to a too fast change of a position by a listener. FIG. 10g shows a determination of a maximum temporal rate of change of the delay, see delay_delta2, based on a maximum allowable listener acceleration. A number of samples the delay change is allowed to change from frame to frame is computed as a function of maximum allowed movement acceleration max_m_s_s. The maximum allowed movement acceleration max_m_s_s may correlate with maximum rate of delay 2nd order change [a in m/s].

The two examples shown in FIGS. 10f and 10g perform the delay processing so that the delays compensate for listener-to-loudspeaker distance variations among the loudspeakers.

Auditory roughness may be mitigated by the following counter-measures:
Updating the VDL by a sample-precision interpolated target delay value (linear interpolation from current value towards target delay value at end of each processing block).
The returned delay value for each output channel is used as target value for an associated variable delay line, which applies the appropriate delay to the corresponding output signal. These output delay lines use the same implementation as the VDLs used in distance rendering within MPEG-I.

Optionally, gains are smoothed with singe-pole averaging, see FIG. 10h. The averaging constant is computed as a function of the smoothing time constant gain_ms.

In case a system or audio processor is already configured to optimize delays and/or gains without considering nearfield and farfield in a reproduction space in which reverberation is effective, it is proposed that the system or audio processor may be configured to calibrate the gain and/or delay adjustment. Calibrated system option cal_system may be used when we are operating on a system which applies already its own optimal gains and delays (and etc.) for the sweet spot. In this case, see FIG. 10i, we are additionally computing the gain and delay compensation of the sweet spot (above, see FIG. 10c, these were computed for the listener position). In this case the difference between the two computations is applied. Beside this differences the compensation gain determination shown in FIG. 10i is based on the same considerations as described with regard to FIG. 10c (same features have been indicated by the same reference numerals).

### Audio Processing

For example, after rendering_gd_updatecfg has been called, the function rendering_gd_process is called, specifying the input and output buffers, see FIG. 11a.

Optionally, the gains are applied with single-pole averaging, see FIG. 11b. For example, a herein described audio processor 10 may be configured to perform a gain adjustment so as to determine, based on a listener position, gains 41. This gain adjustment may be performed by considering a target value, see gain0[ch]. The target value may represent a maximum allowable compensation gain, e.g., determinable using a herein described roll-off gain compensation function, see FIGS. 4, 6, 10c and 10i. A current gain 41a, e.g. a gain determined for a respective loudspeaker without considering that sound energy decays differently in a nearfield and a farfield of the respective loudspeaker, is adjusted with a limited change per time unit, i.e. per sample, towards the target value, i.e. gain0[ch]. At a determination of the target value the different sound energy decay in the nearfield and the farfield of the respective loudspeaker is considered. This prevents artefacts, as the gain changes only slightly per sample. The target value limits the gain change and prevents a too fast or erroneous gain change due to an irregular or too fast change of a listener position.

According to an embodiment, delays may be computed for external delay lines, see FIG. 11c. The delay change per frame, and/or 2nd order delay change per frame is limited, to reduce artefacts and pitch-shifting. For example, a herein described audio processor 10 may be configured to perform a delay processing so as to determine, based on a listener position, delays 51. This delay processing may be performed by considering a target value, see delay0[ch]. The target value may represent a delay for the respective loudspeaker without boundary conditions, e.g. a delay for the actual current listener position, e.g., without considering that an irregular or too fast change of a listener position may have occurred. The target value may be determined as described with regard to FIG. 10d. The delay determined at the delay processing for the respective loudspeaker may be smoothed. For example, the audio processor may be configured to perform at the delay processing a smoothing by determining a smooth transition from a delay (see reference numeral 51a) determined for the respective loudspeaker for a previous frame, i.e. for a frame preceding a current frame, to a delay for a current frame, e.g., to the target value. A smoothed delay, see reference numeral 51, is calculated, assuming that the speed and acceleration of the listener may not exceed certain values, see the consideration of delay_delta at the limitation of the delay change and/or the consideration of delay_delta2 at the limitation of the delay change second order. It may not be necessary to consider both limitations, but artefacts may be reduced more efficiently, if considering both limitations. The variable delay_delta represents the maximum number of samples the delay is allowed to change from frame to frame and may be determined as described with regard to FIG. 10f. The variable delay_delta2 represents the maximum number of samples the delay change is allowed to change from frame to frame and may be determined as described with regard to FIG. 10g. With this the maximum rate of delay change and/or the maximum rate of delay 2nd order change is limited for the purpose of minimizing artefacts.

The returned delay value for each output channel is used as target value for an associated variable delay line, which applies the appropriate delay to the corresponding output signal. These output delay lines use the same implementation as the VDLs.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] “Adaptively Adjusting the Stereophonic Sweet Spot to the Listener's Position”, Sebastian Merchel and Stephan Groth, J. Audio Eng. Soc., Vol. 58, No. 10, October 2010
[2] “AUDIO PROCESSOR, SYSTEM, METHOD AND COMPUTER PROGRAM FOR AUDIO RENDERING”, WO 2018/202324 A1
[3] https://www.princeton.edu/3D3A/PureStereo/Pure_Stereo.html
[4] https://en.wikipedia.org/wiki/Critical_distance

1. Audio processor for performing audio rendering by generating rendering parameters, which determine a derivation of loudspeaker signals to be reproduced by a set of loudspeakers from an audio signal, configured to
perform a gain adjustment so as to determine, based on a listener position, gains for generating the loudspeaker signals for the loudspeakers from the audio signal,
acquire a reverberation effect information;
wherein the audio processor is configured to use, depending on the reverberation effect information, in the gain adjustment, for at least one loudspeaker, a roll-off gain compensation function for mapping a listener-to-loudspeaker distance of the at least one loudspeaker onto a listener-to-loudspeaker-distance compensation gain (46) for the at least one loudspeaker,
wherein the roll-off gain compensation function considers a first decay parameter for a near-field and a second decay parameter for a far-field, so that a compensated roll-off gets monotonically shallower with increasing listener-to-loudspeaker distance.

2. Audio processor of claim 1, wherein the reverberation effect information is indicative of an amount of reverberation effective in a reproduction room of the audio rendering,
wherein the roll-off gain compensation function is adapted so that an intensity at which the compensated roll-off gets monotonically shallower with increasing listener-to-loudspeaker distance is the larger the larger the amount of reverberation effective in a reproduction room is.

3. Audio processor of claim 1, wherein the reverberation effect information is indicative of whether reverberation is effective in the reproduction room of the audio rendering, or not,
wherein the audio processor is configured to use the roll-off gain compensation function, for which the compensated roll-off gets monotonically shallower with increasing listener-to-loudspeaker distance, if the reverberation effect information indicates that reverberation is effective in the reproduction room of the audio rendering, and use a further roll-off gain compensation function for which the compensated roll-off is constant, if the reverberation effect information indicates that reverberation is not effective in the reproduction room of the audio rendering.

4. Audio processor of claim 1, wherein the roll-off gain compensation function comprises a first compensated roll-off slope within a first distance zone and a second compensated roll-off slope within a second distance zone, wherein the first compensated roll-off slope is larger than the second compensated roll-off slope and the first distance zone relates to smaller distances than the second distance zone.

5. Audio processor of claim 4, configured to derive a border distance separating the first and second distance zones from the reverberation effect information.

6. Audio processor of claim 4, configured to derive the first compensated roll-off slope and/or the second compensated roll-off slope from the reverberation effect information.

7. Audio processor of claim 4, configured to derive information on how the roll-off gain compensation function transitions from the first to the second distance zone from the reverberation effect information.

8. Audio processor according to claim 1, wherein the audio processor is configured to perform the gain adjustment so that the listener position becomes a sweet spot relative to the set of loudspeakers in an acoustic or perceptual sense.

9. Audio processor according to claim 1, wherein the audio processor is configured to perform a delay processing so as to determine, based on a listener position, delays for generating the loudspeaker signals for the loudspeakers from the audio signal.

10. Audio processor according to claim 9, wherein the audio processor is configured to perform the delay processing so that the delays compensate for listener-to-loudspeaker distance variations among the loudspeakers.

11. Audio processor according to claim 9, wherein the audio processor is configured to perform the delay processing so that the listener position becomes a sweet spot relative to the set of loudspeakers in an acoustic or perceptual sense.

12. Audio processor according to claim 9, wherein the audio processor is configured to
perform the delay processing by determining the delay for each loudspeaker independent from a delay determined for any other loudspeaker of the set of loudspeakers, or
perform the delay processing by determining a reference loudspeaker among the set of loudspeakers and determining the delays of the loudspeakers other than the reference loudspeaker relative to the delay determined for the reference loudspeaker.

13. Audio processor according to claim 1, wherein the set of loudspeakers are attributed to one or more loudspeaker layers, and the audio processor is configured to
if a desired audio signal's sound source position is between two loudspeaker layers, apply, for each loudspeaker layer of the two loudspeaker layers, a 2D amplitude panning between the loudspeakers of the respective loudspeaker layer so as to determine for the loudspeakers attributed to the respective loudspeaker layer first panning gains for a rendering of the audio signal by the loudspeakers attributed to the respective loudspeaker layer from a virtual source position corresponding to a projection of a desired audio signal's sound source position onto the respective loudspeaker layer, and
apply an amplitude panning between the virtual sound source positions of the two loudspeaker layers, so as to determine for the loudspeaker layers second panning gains for, when applied in addition to the first panning gains, a rendering of the audio signal by the two loudspeaker layers' loudspeakers from the desired audio signal's sound source position.

14. Audio processor according to claim 1, wherein the set of loudspeakers are attributed to one or more loudspeaker layers, and the audio processor is configured to
if a desired audio signal's sound source position is positioned outside the one or more loudspeaker layers,
apply a 2D amplitude panning between the loudspeakers attributed to a nearest loudspeaker layer which is nearest to the desired audio signal's sound source position among the one or more loudspeaker layers, so as to determine for the loudspeakers of the nearest loudspeaker layer the first panning gains for a rendering of the audio signal by the loudspeakers of the nearest loudspeaker layer from a virtual source position corresponding to a projection of a desired audio signal's sound source position onto the nearest loudspeaker layer, and
apply a further amplitude panning between the loudspeakers attributed to the nearest loudspeaker layer along with a spectral shaping of the audio signal so as to result into a sound rendition by the loudspeakers of the nearest loudspeaker layer which mimics sound from a further virtual source position offset from the nearest loudspeaker layer towards the desired audio signal's sound source position, and
apply an even further amplitude panning between the virtual sound source position and the further virtual sound source position, so as to determine second panning gains for a panning between the virtual sound source position and the further virtual sound source position so as to result into a rendering of the audio signal by the nearest loudspeaker layer's loudspeakers from the desired audio signal's sound source position.

15. Audio processor according to claim 14, wherein the audio processor is configured to perform the spectral shaping of the audio signal using a first equalizing function which mimics a timbre of bottom sound if the desired audio signal's sound source position is positioned below to the one or more loudspeaker layers, and/or perform the spectral shaping of the audio signal using a second equalizing function which mimics a timbre of top sound if the desired audio signal's sound source position is positioned above the one or more loudspeaker layers.

16. Audio processor according to claim 1, wherein the audio processor is configured to derive the reverberation effect information from a bitstream.

17. Audio processor according to claim 1, wherein the audio processor is configured to derive the reverberation effect information from side information of bitstream and to decode the audio signal from the bitstream.

18. Method for audio rendering by generating rendering parameters, which determine a derivation of loudspeaker signals to be reproduced by a set of loudspeakers from an audio signal, the method comprising
performing a gain adjustment so as to determine, based on a listener position, gains for generating the loudspeaker signals for the loudspeakers from the audio signal,
acquiring a reverberation effect information;
wherein, depending on the reverberation effect information, the gain adjustment uses, for at least one loudspeaker, a roll-off gain compensation function for mapping a listener-to-loudspeaker distance of the at least one loudspeaker onto a listener-to-loudspeaker-distance compensation gain for the at least one loudspeaker,
wherein the roll-off gain compensation function considers a first decay parameter for a near-field and a second decay parameter for a far-field, so that a compensated roll-off gets monotonically shallower with increasing listener-to-loudspeaker distance.

19. A non-transitory digital storage medium having a computer program stored thereon to perform the method for audio rendering by generating rendering parameters, which determine a derivation of loudspeaker signals to be reproduced by a set of loudspeakers from an audio signal, the method comprising
performing a gain adjustment so as to determine, based on a listener position, gains for generating the loudspeaker signals for the loudspeakers from the audio signal,
acquiring a reverberation effect information;
wherein, depending on the reverberation effect information, the gain adjustment uses, for at least one loudspeaker, a roll-off gain compensation function for mapping a listener-to-loudspeaker distance of the at least one loudspeaker onto a listener-to-loudspeaker-distance compensation gain for the at least one loudspeaker,
wherein the roll-off gain compensation function considers a first decay parameter for a near-field and a second decay parameter for a far-field, so that a compensated roll-off gets monotonically shallower with increasing listener-to-loudspeaker distance,
when said computer program is run by a computer.

20. Bitstream (or digital storage medium storing the same) as mentioned in claim 16.
